(19) United States
(12) Patent Application Publication
(10) Pub. No.: US 2025/0097356 A1
(43) Pub. Date: Mar. 20, 2025

(54) IMAGE PROCESSING APPARATUS, CONTROL METHOD OF IMAGE PROCESSING APPARATUS, AND RECORDING MEDIUM

(71) Applicant: CANON KABUSHIKI KAISHA, Tokyo (JP)

(72) Inventor: KENTA INOUE, Chiba (JP)

(21) Appl. No.: 18/828,982

(22) Filed: Sep. 9, 2024

(30) Foreign Application Priority Data
Sep. 19, 2023 (JP) 2023-151689

(51) Int. Cl. H04N 1/00

(52) U.S. Cl. CPC H04N 1/00244; H04N 1/0044; H04N 1/00477

(57) ABSTRACT

An image processing apparatus comprising: at least one memory storing instructions; and at least one processor executing the instructions causing the image processing apparatus to: transmit image data obtained by scanning a document to an external server, wherein information corresponding to the image data transmitted to the external server is displayed on a display of a client terminal capable of communicating with the external server; display a list in which logs of a plurality of jobs including a log of a job that transmits the image data to the external server are displayed; receive selection of a log of a job that transmits the image data to the external server in the list; and receive an instruction to delete information corresponding to the image data that has been transmitted to the external server in a job corresponding to the selected log, wherein information corresponding to the image data displayed on a display of the client terminal is deleted.

### BACKGROUND OF THE INVENTION

### Field of the Invention

The present invention relates to an image processing apparatus, a control method of the image processing apparatus, and a recording medium.

### Description of the Related Art

The use of chat services in business is on the rise due to the increased use of remote work and teamwork efficiency. Talk rooms in chat services are divided into channels for different topics. Users can select a desired channel to post a chat. Japanese Patent Application Laid-Open No. 2022-11930 discloses that an image processing apparatus transmits image data generated by scanning an image of an original to a chat server that provides a chat service. By specifying a transmission destination channel from the image processing apparatus and transmitting a scanned image to a chat server, the image data is uploaded to a talk room of the specified channel of the chat service and shared.

However, in Japanese Patent Application Laid-Open No. 2022-11930, if a user notices an error in a scanned document after transmission or an error in a transmission destination channel, the user cannot delete data posted to the chat service from the image processing apparatus.

### SUMMARY OF THE INVENTION

The present invention enables an image processing apparatus to instruct deletion of a post from the image processing apparatus to a chat service.

An image processing apparatus of the present invention comprising: at least one memory storing instructions; and at least one processor executing the instructions causing the image processing apparatus to: transmit image data obtained by scanning a document to an external server, wherein information corresponding to the image data transmitted to the external server is displayed on a display of a client terminal capable of communicating with the external server; display a list in which logs of a plurality of jobs including a log of a job that transmits the image data to the external server are displayed; receive selection of a log of a job that transmits the image data to the external server in the list; and receive an instruction to delete information corresponding to the image data that has been transmitted to the external server in a job corresponding to the selected log, wherein information corresponding to the image data displayed on a display of the client terminal is deleted.

Further features of the present invention will become apparent from the following description of exemplary embodiments with reference to the attached drawings.

### BRIEF DESCRIPTION OF THE DRAWINGS

FIG. 1 is a diagram showing the overall configuration of an image processing system.

FIG. 2 is a diagram showing the hardware configuration of an MFP.

FIG. 3 is a diagram showing the hardware configuration of an MFP cooperative server, a chat server, and a client PC.

FIG. 4 is a diagram showing the software configuration of the image processing system.

FIG. 5 is a sequence diagram showing a flow of the scan image posting processing.

FIG. 6 is a diagram showing an example of a login screen.

FIG. 7 is a diagram showing an example of a home screen.

FIG. 8 is a diagram illustrating an example of application setting information.

FIG. 9 is a diagram illustrating an example of user information.

FIGS. 10A and 10B are diagrams showing an example of a scan screen.

FIGS. 11A and 11B are diagrams showing an example of a chat screen.

FIGS. 12A and 12B are diagrams showing an example of a chat screen.

FIG. 13 is a diagram showing an example of the chat screen.

FIGS. 14A and 14B are diagrams showing an example of a job history.

FIG. 15 is a diagram showing an example of an access authorization setting screen.

FIG. 16 is a flowchart showing scanned image posting processing.

FIG. 17 is a flowchart showing the scanned image posting processing.

FIG. 18 is a sequence diagram showing the flow of post deletion processing.

FIG. 19 is a diagram showing an example of a history screen.

FIG. 20 is a diagram showing an example of the history screen.

FIG. 21 is a diagram showing an example of the history screen.

FIG. 22 is a diagram showing an example of the history screen.

FIG. 23 is a flowchart showing the post deletion processing.

FIG. 24 is a flowchart showing the post deletion processing in an MFP 110.

FIG. 25 is a flowchart showing the post deletion processing in an MFP cooperative server 120.

FIG. 26 is a sequence diagram showing the flow of chatbot account registration processing.

FIG. 27 is a diagram illustrating an example of chatbot connection information.

### DESCRIPTION OF THE EMBODIMENTS

### First Embodiment

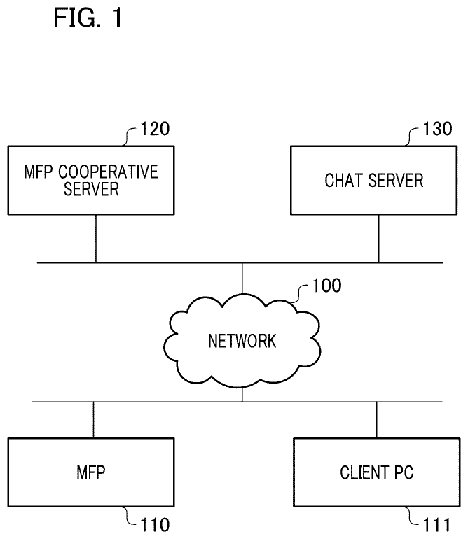

FIG. 1 is a diagram showing the overall configuration of an information processing system according to the present embodiment. The information processing system includes an MFP (Multifunction Peripheral) 110, an MFP cooperative server 120, and a chat server 130. Additionally, the information processing system may also include a client PC 111. The MFP 110, the client PC 111, the MFP cooperative server 120, and the chat server 130 are communicatively connected via a network 100. For example, the MFP 110 and the client PC 111 are communicably connected to various servers that provide various services on the Internet via a local area network (LAN). Note that it suffices if the network 100 is configured in any communication system as long as it is capable of transmitting and receiving data. For example, the network 100 may be configured by any one of a LAN, a WAN, a cellular network, for example, LTE or 5G, a wireless network, a telephone line, a dedicated digital line, and the like, or a combination of these.

The MFP 110 is an example of an image processing apparatus having a scanning function and a posting function. The MFP 110 has a plurality of functions such as a printing function and a BOX storage function in addition to a scanning function. The MFP 110 is connected to the network 100 and can communicate with an external device on the network 100. Note that the MFP 110 in the present embodiment communicates with the chat server 130 via the MFP cooperative server 120. The MFP 110 of the present embodiment has an additional application that can send and post scanned images to a chat service provided by the chat server 130. The MFP 110 transmits a scanned image file and a message posting request to the chat server 130 via the MFP cooperative server 120. Additionally, the MFP 110 transmits a request to delete the post posted from the MFP 110 to the chat server 130 via the MFP cooperative server 120.

The client PC 111 is an information processing apparatus that can receive cloud services via the network 100. The client PC 111 may be a desktop terminal and a mobile terminal including a notebook computer, a tablet, and a smartphone. The client PC 111 uses, for example, a chat service provided by the chat server 130 via a web browser and displays a chat screen (talk room).

The MFP cooperative server 120 is an information processing apparatus that provides an MFP cooperative service. As part of the MFP cooperative service, the MFP cooperative server 120 provides a service of transferring information obtained from the MFP 110 to a server that provides another service. The MFP cooperative server 120 of the present embodiment relays communication between the MFP 110 and the chat server 130. For example, the MFP cooperative server 120 receives a request to post a scanned image file and the like from the MFP 110 and transfers the request to the chat server 130. Additionally, the MFP cooperative server 120 receives a request to delete a post from the MFP 110 and transfers the request to the chat server 130. Furthermore, the MFP cooperative server 120 transfers a response received from the chat server 130 to the MFP 110. The MFP cooperative service is, for example, a cloud service. Note that MFP cooperative server 120 may be realized by one or more information processing apparatuses, a virtual machine (cloud service) using resources provided by a data center including an information processing apparatus, or a combination of these.

The chat server 130 is an information processing apparatus that provides a chat service. As a chat service, the chat server 130 displays file data and character string information that have been transmitted via the network 100, and shares information in response to a request from the web browser of the client PC 111. In the present embodiment, the chat server 130 displays images and the like that have been sent from the MFP 110 via the MFP cooperative server 120 on a chat screen. The chat service is a cloud service or a collaboration service. Note that the chat server 130 may be realized by one or more information processing apparatuses, a virtual machine (cloud service) using resources provided by a data center including an information processing apparatus, or a combination of these.

Although the information processing system of the present embodiment includes the MFP 110, the client PC 111, the MFP cooperative server 120, and the chat server 130, the present invention is not limited thereto. For example, the MFP 110 may also function as the client PC 111 and the MFP cooperative server 120. Additionally, the MFP cooperative server 120 and the chat server 130 may be located on a LAN rather than on the Internet. Furthermore, the MFP cooperative server 120 and the chat server 130 do not have to be independent services.

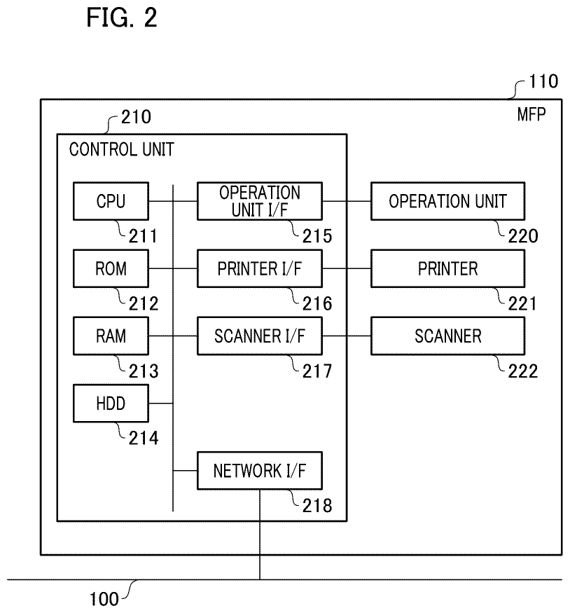

FIG. 2 is a diagram showing the hardware configuration of the MFP 110. The MFP 110 has a control unit 210, an operation unit 220, a printer 221, and a scanner 222. The control unit 210 controls the overall operation of the MFP 110. The control unit 210 has a CPU 211, a ROM 212, a RAM 212, a HDD 214, an operation unit I/F 215, a printer I/F 216, a scanner I/F 217, and a network I/F 218.

The CPU 211 reads out a control program stored in the ROM 212 or the HDD 214, and executes various control processing of the MFP 110. The ROM 212 stores the programs executed by the CPU 211. The control performed by the CPU 211 also includes the execution of programs for implementing the flowcharts to be described below. The RAM 212 is used as a main memory of the CPU 211, and a temporary storage area including a work area. The HDD 214 is a storage device that stores image data, various programs, and various setting information. Note that the MFP 110 may also include another storage device, for example, a solid state drive (SSD). Although, in the present embodiment, one CPU 211 executes each process as shown in flowcharts to be described below using one memory (RAM 213 or HDD 214), the present invention is not limited thereto. For example, each process may be executed by using a plurality of CPUs, RAMs, or HDDs in cooperation with each other.

The operation unit I/F 215 connects the operation unit 220 and the control unit 210. The operation unit 220 includes, for example, a display unit having a touch panel function, various hard keys, and the like. By associating input coordinates and display coordinates on the touch panel, it is possible to configure a GUI as if a user can directly operate the screen displayed on the touch panel. Note that the touch operation on the touch panel includes an operation using a human finger and an operation using a touch pen. The operation unit 220 functions as a display unit that displays information to the user and functions as a reception unit that receives instructions from the user.

The printer I/F 216 connects the printer 221 and the control unit 210. The printer 221 prints an original read by a reader and image data stored in the HDD 214 onto a recording medium (for example, onto paper). Additionally, the printer 221 prints image data based on a print job. Image data to be printed by the printer 221 is transferred from the control unit 210 to the printer 221 via the printer I/F 216. The scanner I/F 217 connects the scanner 222 to the control unit 210. The scanner 222 reads an original placed on a platen or an ADF (Auto Document Feeder) and generates image data. The generated image data is input to the control unit 210 via the scanner I/F 217. The image data generated by the scanner 222 can be printed by the printer 221 (copy output), stored in the HDD 214, and transmitted to external devices such as the MFP cooperative server 120 via the network 100 by file transmission, mail transmission, and the like. Note that although, in the present embodiment, an example has been explained in which the MFP 110 has a printing function and a scanning function, the MFP 110 only needs to have a scanning function.

The network I/F 218 is a communication interface that connects the MFP 110 and the network 100. For example, a network cable is connected to the network I/F 218 of the MFP 110, and communication with an external apparatus on the network 100 can be executed. The MFP 110 transmits and receives image data and information to and from each service on the Internet using the network I/F 219. Although, in the present embodiment, it is assumed that the network I/F 218 is a communication interface that performs wired communication, the present invention is not limited thereto. For example, the network I/F 218 may be a wireless communication interface. Note that the hardware configuration of the MFP 110 as explained above is merely an example, and the MFP 110 may include other configurations as necessary or need not include some of the configurations.

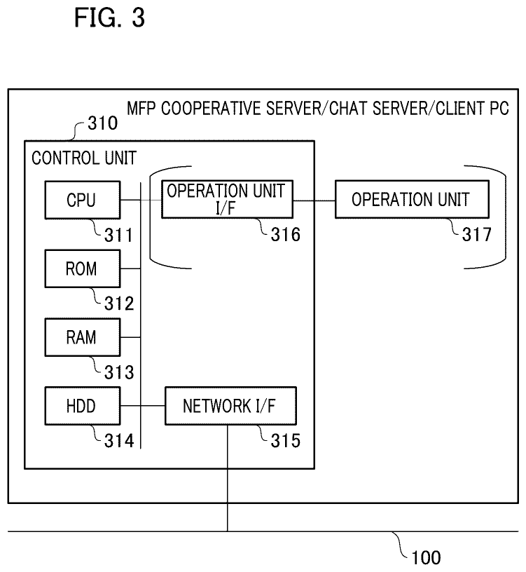

FIG. 3 is a diagram illustrating an example of the hardware configuration of the MFP cooperative server 120. In addition, the chat server 130 and the client PC 111 also have hardware configuration similar to the MFP cooperative server 120. The MFP cooperative server 120 includes a control unit 310. The control unit 310 includes a CPU 311, a ROM 312, a RAM 313 an HDD 314, and a network I/F 315. The client PC 111 may also include an operation unit 317. In addition, in the case where the client PC 111 includes the operation unit 317, the control unit 310 includes an operation unit I/F 316 for connecting to the operation unit 317.

The CPU (Central Processing Unit) 311 controls the entire MFP cooperative server 120. The CPU 311 reads out a control program stored in the ROM 312 or the HDD 314, and executes various control processing. The control performed by the CPU 311 also includes the execution of programs for realizing the flowcharts to be described below. The ROM (Read Only Memory) 312 is a memory dedicated to reading out data, and stores, for example, a basic control program of the MFP cooperative server 120. The random-access memory (RAM) 312 is a data-readable/writable memory, and is used as a temporary storage area such as a work area of the CPU 311.

The hard disk drive (HDD) 314 stores various data and programs. Note that although an example in which the MFP cooperative server 120 includes an HDD 314 as a storage unit will be explained in the present embodiment, the present invention is not limited thereto, and the MFP cooperative server 101 may include another storage unit, for example, an SSD and a Disk Drive into which an external medium is loaded. The Network I/F 315 connects the MFP collaboration server 120 to the network 100. The MFP cooperative server 120 transmits and receives various types of information to and from external devices on the network 100 via the network I/F 315 and the network 100. The MFP cooperative server 120 receives requests of various processing from external devices via the network I/F 315, and returns the result of processing according to the requests.

The client PC 111 further has the operation unit I/F 316 and an operation unit 317. The operation unit I/F 316 is an interface that connects the operation unit 317 and the control unit 310. The operation unit 317 has, for example, a keyboard, a pointing device, and a display. The operation unit 317 functions as a display unit that displays information to the user and functions as a reception unit that receives instructions from the user.

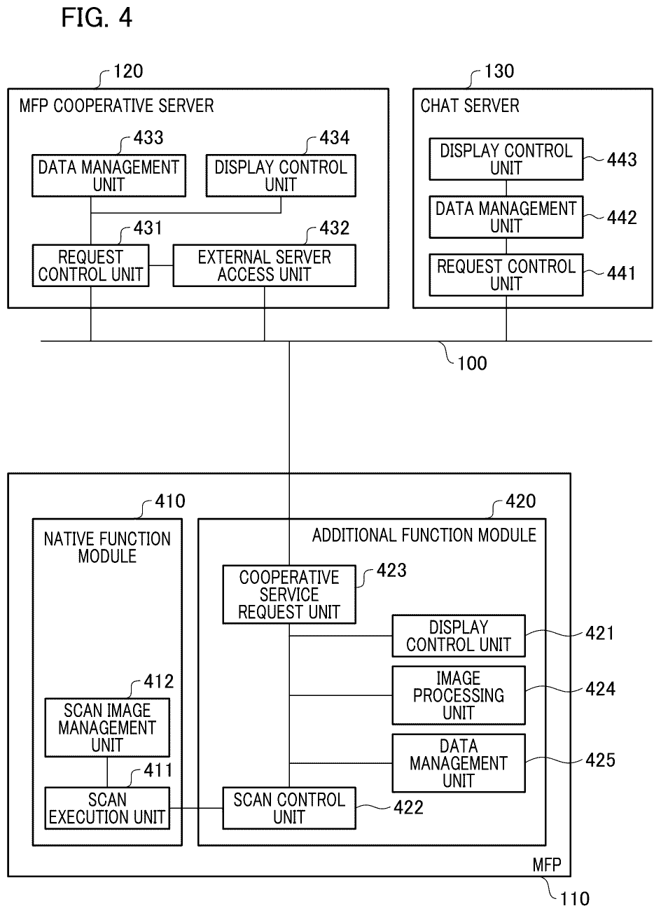

FIG. 4 is a diagram showing a software configuration of the information processing system. Hereinafter, among the functions of each device of the information processing system will be explained, only the functions related to the processing of transmitting an image scanned by the MFP 110 to the chat server 130 via the MFP cooperative server 120 and the processing of deleting a post from the MFP 110.

First, the functional modules of the MFP 110 will be explained. The MFP 110 has a native function module 410 and an additional function module 420. The native function module 410 is an application that is provided as standard in the MFP 110. The additional function module 420 is an application additionally installed in the MFP 110 (hereinafter, referred to as an “additional application”). The additional function module 420 is, for example, a Java-based application, and can easily realize adding functions to the MFP 110. Note that another additional application (not illustrated) may be installed in the MFP 110. The software modules of the MFP 110 are realized by the CPU 211 of the MFP 110 executing a program stored in a memory (the ROM 212 or the HDD 214).

The native function module 410 has a scan execution unit 411 and a scan image management unit 412. The scan execution unit 411 executes the scan processing using the scanner 222 based on an instruction from the scan execution unit 411, and generates scan image data. The scan image management unit 412 stores the scanned image generated by the scan processing performed by the scan execution unit 411 in an HDD 214, and manages the scanned image data.

The additional function module 420 has a display control unit 421, a scan control unit 422, a cooperative service request unit 423, an image processing unit 424, and a data management unit 425. The display control unit 421 controls the display on the operation unit 220. The display control unit 421 displays, for example, a user interface screen (UI screen) for receiving various user operations on the touch panel of the operation unit 220. The various user operations include, for example, input of login authentication information, scan settings, a setting of transmission destination information, a setting of scan file attribute information, an instruction to start scanning, transmission instruction, and the like.

In response to a user operation (for example, pressing a scan start button) performed on the UI screen, the scan control unit 422 instructs the scan execution unit 411 of the native function module 410 to execute the scan processing together with scan setting information. The scan execution unit 411 causes the scanner 222 to execute an operation to read a document and the like via the scanner I/F 217 according to an instruction to execute scan processing from a scan control unit 422, and scan image data is generated. The generated scan image data is stored in the HDD 214 by the scan image management unit 412.

When storing the scanned image data in the HDD 214, the scan image management unit 412 issues a scanned image identifier that uniquely identifies the scanned image data to be stored and stores the scanned image identifier in association with the scanned image data. Then, the scan image management unit 412 provides notification about information on the scan image identifier to the scan control unit 422. The scanned image identifier is, for example, a number, a symbol, an alphabet, and the like for uniquely identifying an image scanned by the MFP 110. The scan control unit 422 acquires, for example, the scanned image data to be converted into a file from the scan image management unit 412 by using the scan image identifier, and converts the data into a file in the image processing unit 424. Then, the scan control unit CPU 422 instructs the cooperative service request unit 423 to request for the processing necessary for file transmission to the MFP cooperative server 120.

The cooperative service request unit 423 requests various processing to the MFP cooperative server 120, and receives responses thereto. The various processing to the MFP cooperative server 120 includes, for example, a request to obtain settings for additional applications, transmitting a file of scanned image data, and the like. Additionally, in the present embodiment, the cooperative service request unit 423 also transmits, to the MFP coordinated server 120 that relays the communication, a posting request and a post deletion request to the chat service to the chat server 130. Specifically, the cooperative service request unit 423 also functions as a transmission unit (first transmission unit) that transmits a posting request to the chat service and a transmission unit (second transmission unit) that transmits a deletion request to the chat service. For the communication between the MFP 110 and the MFP cooperative server 120, communication protocols such as REST and SOAP are used.

The image processing unit 424 performs predetermined image processing on the scanned image data and generates an attribute used in the UI screen displayed by the display control unit 421 including a transmission destination and a file name. The data management unit 425 manages data used in the MFP 110, such as acquiring information stored in the HDD 214, and storing setting information and transmission result information received from the MFP cooperative server 120 via the cooperative service request unit 423 in the HDD 214. The information managed by the data management unit 425 includes, for example, user information during login, setting information of an additional application, and a job history.

Next, a software configuration of the MFP cooperative server 120 will be explained. The MFP cooperative server 120 has a request control unit 431, an external server access unit 432, a data management unit 433, and a display management unit 434. The request control unit 431 is on standby in a state in which it can receive a request from an external apparatus including the MFP 110, and instructs the external server access unit 432 and the data management unit 433 to execute predetermined processing according to the content of the received request.

The external server access unit 432 performs a process request to the chat server 130. In the cloud service, various interfaces for transmitting data such as a file and a message to the chat server 130 using protocols such as REST and SOAP, and acquiring information on the chat service are disclosed. The external server access unit 432 performs a request to the chat server 130 by using the disclosed interface.

The data management unit 433 holds and manages user information, various setting data, and the like managed by the MFP cooperative server 120. The display control unit 434 receives a request from a web browser operating on the MFP 110 and the client PC 111 connected via the Internet, and returns screen configuration information (for example, HTML and CSS.) necessary for screen display. The user can confirm user information registered in the MFP cooperative server 120 and change scan settings and settings related to transmission information via a screen displayed by the web browser.

Next, a software configuration of the chat server 130 will be explained. The chat server 130 has a request control unit 441, a data management unit 442, and a display control unit 443. The request control unit 441 receives a request from an external apparatus, issues an instruction corresponding to the request to the data management unit 442, and returns a response corresponding to the request to the transmission source of the request. The request control unit 441 of the present embodiment is on standby in a state in which a request from the MFP cooperative server 120 can be received, and instructs the data management unit 442 to store a message and a file in response to the request, and to read out data managed by the chat server 130. Then, the request control unit 441 returns the result of the processing corresponding to the request to the transmission source of the request as a response. In a case where the request is a post, an identifier that uniquely identifies the post issued by the data management unit 442 is included in the response. That is, the request control unit 441 also functions as a transmission unit that transmits an identifier that uniquely identifies a post to a request source of the post.

The data management unit 442 posts and stores a message and a file and reads out and deletes data managed by the chat server 130, based on an instruction from the request control unit 441. That is, the data management unit 442 functions as a posting unit that posts a message and a file and issues an identifier that uniquely identifies the post. The data management unit 442 also functions as a deletion unit that deletes posts. The display control unit 443 receives a request from a web browser operating on the MFP 110 and the client PC111 connected via the Internet, and returns screen configuration information (HTML-CSS or the like) necessary for screen display. The user can acquire a saved file and confirm a message via a screen displayed by the web browser.

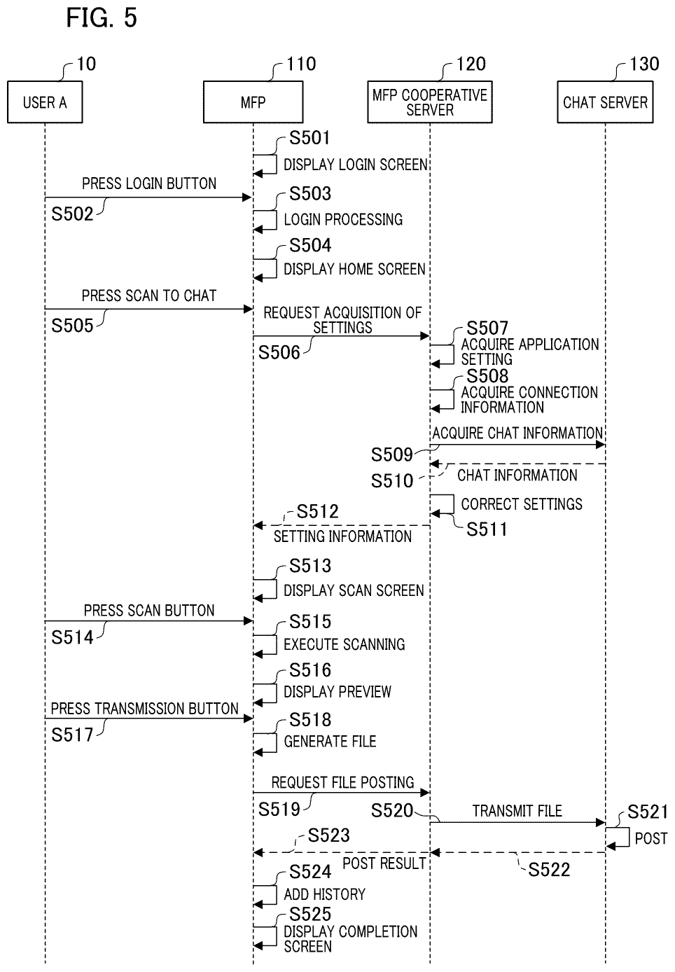

FIG. 5 is a sequence diagram showing the flow of a scanned image posting processing in which an image scanned by the MFP 110 is converted into a file and transmitted to a chat service. Here, an explanation will be given focusing on exchanges between the devices of the information processing system. Each process executed by the MFP 110 is realized by the CPU 211 of the MFP 110 executing a program stored in a memory (the ROM 212 or the HDD 214). Each process executed by MFP cooperative server 120 is realized by the CPU 311 of the MFP cooperative server 120 executing a program stored in a memory (ROM 312 or HDD 314). Each process executed by the chat server 130 is realized by the CPU 311 of the chat server 130 executing a program stored in a memory (ROM 312 or HDD 314).

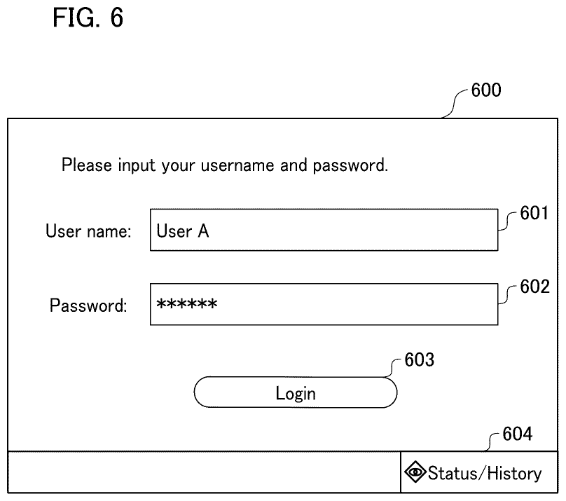

In S501, the MFP 110 displays a login screen in a case where the setting for which authentication by a user is required during use is made. FIG. 6 is a diagram showing an example of a login screen. A login screen 600 is a screen for acquiring information for performing user authentication. When a combination of a user name and a password is used for user authentication, a user name input area 601 and a password input area 602 for inputting user information, and a login button 603 are displayed on the login screen 600. Additionally, a status history button 604 may be displayed on the login screen 600. The status history button 604 is a button for displaying the status and history of a job that is being executed or has been executed in the MFP 110.

In S502, the user 10 inputs a user name registered in the MFP 110 in the user name input area 601 and a password in the password input area 602 on the login screen 600, and presses the login button 603. Thereby, in S502, the MFP 110 detects the pressing of the login button 603 by the user. In S503, the MFP 110 performs user authentication. The MFP 110 verifies whether or not the combination of the user name and password input by the user matches the combination of the user name and password registered in the HDD 214 of the MFP 110. Note that in the present embodiment, although an example has been explained in which verification is performed using user information registered in the MPF 110, verification processing may be executed by the MFP cooperative server 120. In a case where the MFP cooperative server 120 performs user authentication, the MFP cooperative server 120 verifies a user name and a password transmitted from the MFP 110 to the MFP cooperative server 120, and returns a result to the MFP 110. The user authentication method using the user information is performed using other generally known methods (Basic authentication, Digest authentication, authorization using OAuth, and the like). Additionally, user authentication using an IC card and biometric authentication may also be performed.

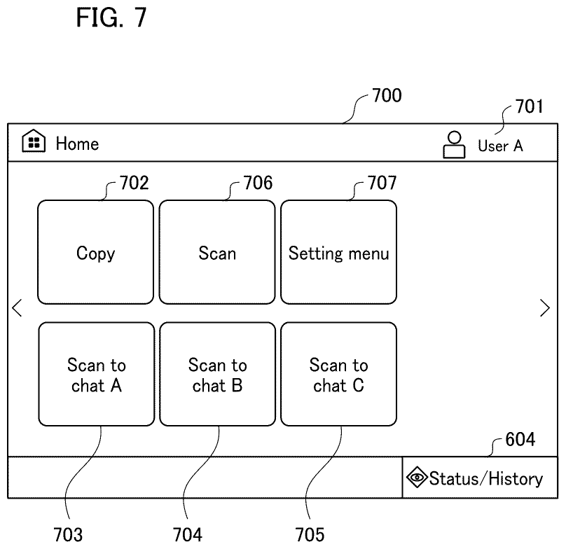

When the user authentication is successful, in S504, the MFP 110 displays a home screen on which buttons for implementing the functions provided by the MFP 110 are arranged. FIG. 7 is a diagram showing an example of a home screen. On a home screen 700, buttons for executing functions provided by the MFP 110 are displayed. For example, a copy button 702, a scan button 706, a setting menu button 707, and a scan-to-chat button 703 are displayed on the home screen 700. Additionally, on the home screen 700, a user display 701 that displays a name of a user who is logging in, the status history button 604, and buttons corresponding to additional applications (for example, a scan-to-chat button 704 and a scan-to-chat button 705) may be displayed. When the user display 701 is pressed down, the MFP 110 displays a menu from which editing of user information, logout, and the like can be selected. The user A displayed on the user display 701 in FIG. 7 corresponds to the user 10 in FIG. 5.

The copy button 702, the scan button 706, and the setting menu button 707 are buttons for activating native functions of the MFP 110. The copy button 702 is a button for activating a copy function. The scan button 706 is a button for activating a scan function. The setting menu button 707 is a button for performing settings of the MFP 110. The scan-to-chat buttons 703 to 705 are buttons for activating additional applications installed in the MFP 110. The scan-to-chat button 703 is a button for activating an application that transmits a scanned image to the chat service A. Similarly, the scan-to-chat button 704 is a button for activating an application that transmits a scanned image to the chat service B. The scan-to-chat button 705 is a button for activating an application that transmits a scanned image to the chat service C.

In S505, the user 10 presses down the scan-to-chat button 703 displayed on the home screen 700. Thereby, in S505, the MFP 110 detects that the user has pressed down the scan-to-chat button 703. In S506, the MFP 110 transmits an acquisition request for application setting information necessary for using the additional application corresponding to the scan-to-chat button 703 to the MFP cooperative server 120. The acquisition request transmitted from the MFP 110 to the MFP cooperative server 120 includes the information on the logged-in user, the device information, and the information on the pressed application. The application information includes information on a corresponding service. That is, the user information of the user A, the device information of the MFP 110, and the application information indicating the chat service A are transmitted to the MFP cooperative server 120 together with the acquisition request for the application setting information.

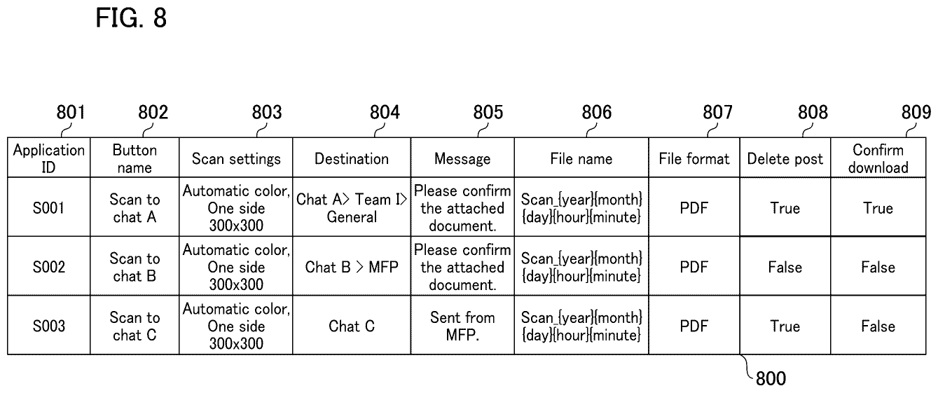

In S507, the MFP cooperative server 120 that has received the acquisition request for the application setting information from the MFP 110 acquires the application setting information from the data management unit 433 of the MFP cooperative server 120. FIG. 8 is a diagram illustrating an example of application setting information. The application setting information is managed as an application setting table 800 by the data management unit 433 of the MFP cooperative server 120. The application setting table 800 includes, for example, an application ID 801, a button name 802, a scan setting 803, a transmission destination 804, a message 805, a file name 806, a file format 807, a post deletion 808, and download confirmation 809.

The application ID 801 is an ID uniquely identifying an application. For example, an application whose application ID 801 is S001 corresponds to the chat service A, an application whose application ID 801 is S002 corresponds to the chat service B, and an application whose application ID 801 is S003 corresponds to the chat service C. The button name 802 is a button name displayed on the home screen 700 of the MFP 110. The scan setting 803 is an initial value of the scan setting. The scan settings include, for example, color/monochrome, single-sided/double-sided, and the resolution of a scanned image. The transmission destination 804 is an initial value of the chat service and the talk room serving as the transmission destination of the scanned image.

The message 805 is an initial value of a message to be transmitted together when the scanned image is transmitted to the chat service. The file name 806 is an initial value of the file name. In the example shown in FIG. 8, “Scan_{year} {month} {day} {minute}” is set as the file name 806. When the application is executed, the parenthesized portion is replaced with a specific character. In the example as shown in FIG. 8, the dynamic part of the file name is replaced with the year, month, day, hour, and minute at the time of obtaining the application settings.

The file format 807 is a file format for converting a scanned image. The post deletion 808 indicates whether or not the chat service supports a post deletion function of chat to be described below. For example, in the post deletion 808, a value “True” is stored in a case where the chat service supports the post deletion function, and a value “False” is stored in a case where the chat service does not support the post deletion function. The download confirmation 809 indicates whether or not the chat service supports a function of confirming whether or not a file transmitted to a chat (to be described below) has been downloaded by someone. For example, in the download confirmation 809, a value “True” is stored in a case where the function of the download confirmation is supported, and a value “False” is stored in a case where the function of the download confirmation is not supported. In the present embodiment, since the scan-to-chat button 703 pressed in MFP 110 is a button corresponding to the chat service A, in S507, the MFP cooperative server 120 acquires each value corresponding to the application IDs “S001”.

In S508, the MFP cooperative server 120 acquires the connection information of the user used for confirming whether or not the user can connect to the chat service of the transmission destination acquired by the application setting information. The MFP cooperative server 120 acquires the connection information from the user information managed by the data management unit 433 of the MFP cooperative server 120 based on the user information and the application information received from the MFP110 together with the acquisition request for the application setting information. In the user information, information that identifies a user, information on a service registered by the user, and connection information to the service are managed in association with each other. In the present embodiment, the MFP cooperative server 120 acquires the connection information corresponding to the user A who is currently logged in to the MFP 110 and the chat service A.

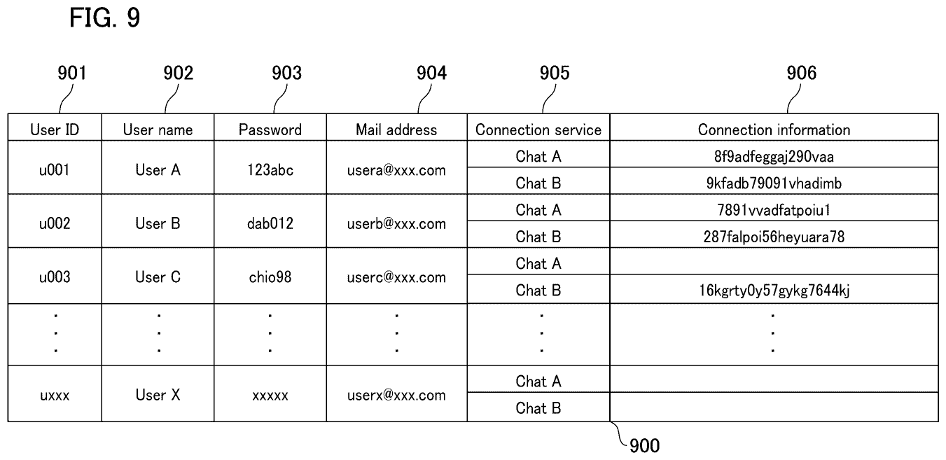

FIG. 9 is an example of user information managed by the MFP cooperative server 120. The user information is managed as a user information table 900 by the data management unit 433 of the MFP cooperative server 120. The user information table 900 includes, for example, a user ID 901, a user name 902, a password 903, an mail address 904, a connection service 905, and connection information 906.

The user ID 901 is an ID uniquely indicating a user. The user name 902 is the name of the user. The password 903 is a password of the user. The mail address 904 is a mail address of the user. The mail address 904 is used when the client PC 111 accesses the MFP cooperative server 120. The connection service 905 is a service of a connection destination (for example, a chat service). The connection information 906 is information necessary for connecting to a service, and a value is stored for each service. For example, an access token and a session ID are stored in the connection information 906. The connection information 906 needs to be acquired by the user permitting connection between the MFP cooperative server 120 and each chat service before using each application. In the example as shown in FIG. 9, the MFP cooperative server 120 acquires the connection information “8f9adfeggaj290vaa” corresponding to the user A and the chat A as the connection information.

In S509, the MFP cooperative server 120 performs a chat information acquisition request to the chat server 130 that provides the chat service A by using the connection information acquired in S508. In S510, the chat server 130 acquires chat information based on the connection information, and responds to the MFP cooperative server 120. The chat information includes, for example, information on a talk room in which the user can post a chat on the chat. In the present embodiment, the MFP cooperative server 120 transmits the connection information of the user A to the chat server 130, and the chat server 130 transmits the chat information including the information on the talk room list in which the user A can post a chat on the chat A, to the MFP cooperative server 120.

In S511, the MFP cooperative server 120 checks whether or not the user can post a chat in the talk room set as the initial value of the transmission destination 804 in the setting information table (FIG. 8) of the application based on the chat information acquired in S510. In addition, in a case where the initial value of the transmission destination 804 is a talk room in which the user cannot post a chat, the setting is corrected according to the range accessible by the user. For example, as the correction, the MFP cooperative server 120 deletes the information on the talk room set as the initial value of the transmission destination 804. In S512, the MFP cooperative server 120 transmits the application setting information (FIG. 8) and the chat information including the list of talk rooms acquired in S510 to the MFP 110.

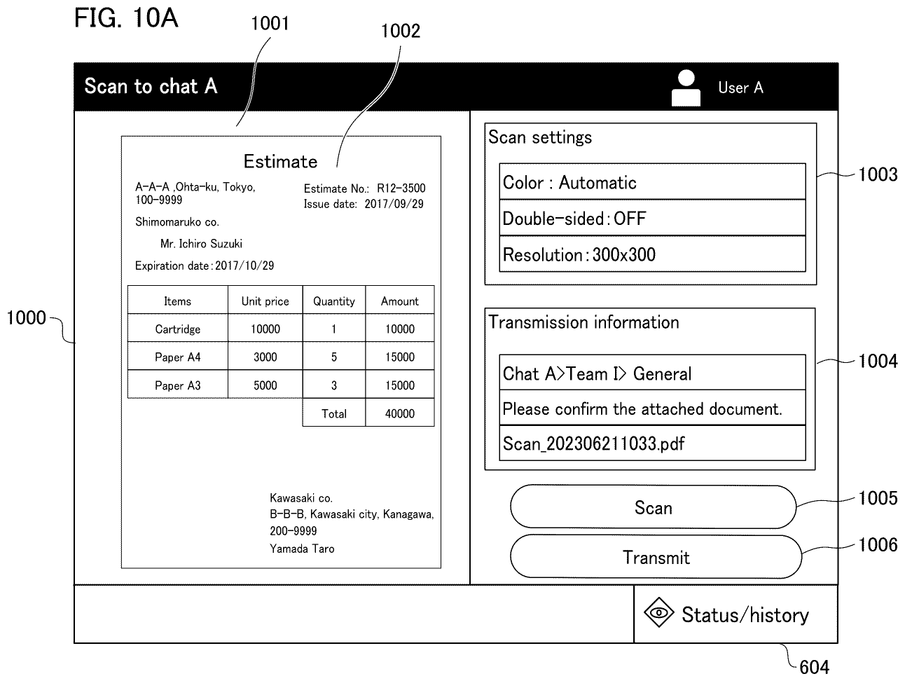

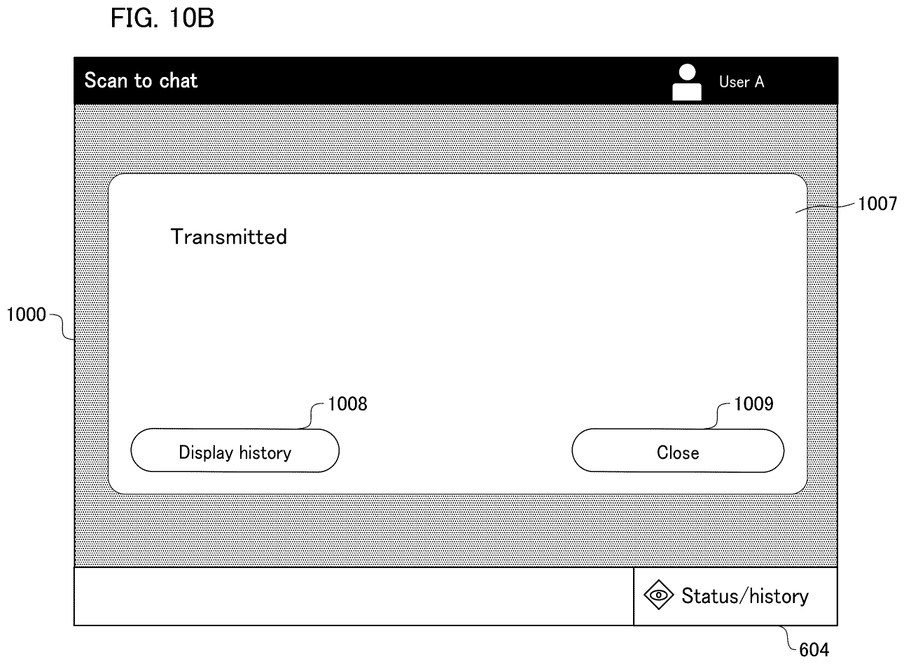

In S513, the MFP 110 displays a scan screen based on the acquired application setting information and the acquired chat information. FIGS. 10A and 10B are diagrams showing an example of a scan screen. FIG. 10A shows an example of the scan screen after scan execution. A scan screen 1000 includes a preview region 1001, scan settings 1003, transmission information 1004, a scan button 1005, and a transmission button 1006. In the preview region 1001 after scan is executed, a preview image 1002 generated from the scanned image is displayed. Note that an image or text (both not illustrated) for prompting the user to perform scanning may be displayed in the preview region 1001 before scan is executed.

The scan settings 1003 displays a setting for scanning an original. In the scan settings 1003, for example, a color mode, a double-sided setting, a resolution, and the like are displayed. The MFP 110 displays the scan settings 1003 based on the scan settings 803 included in the application setting information that has been acquired from the MFP cooperative server 120. In the transmission information 1004, information on posting of the scanned image to the chat is displayed. In the transmission information 1004, for example, information of a talk room serving as a transmission destination, a message to be posted together with the scanned image, and a file name are displayed. The MFP 110 displays the transmission information 1004 based on the application setting information and the chat information acquired from the MFP cooperative server 120 and the year, month, date, hour, and minute when the scan is executed. In the scan settings 1003 and the transmission information 1004, the user can press each setting to display an edit screen (not illustrated) and change the setting. The scan button 1005 is a button for instructing the execution of a scan. The transmission button 1006 is a button for instructing transmission of a scanned image to the chat.

In S514, the user 10 issues a scan instruction by pressing the scan button 1005. Thereby, in S514, the MFP 110 detects that the user has pressed the scan button 1005. In S515, the MFP 110 executes scan of an original and generates a scanned image. In S516, the MFP 110 displays the preview image 1002 generated from the scanned image in the preview region 1001.

In S517, the user 10 provides an instruction to transmit to the chat by pressing the transmission button 1006. Thereby, in S517, the MFP 110 detects that the user has pressed the transmission button 1006. In S518, the MFP 110 generates a file from the scanned image. The MFP 110 assigns the file name set in the transmission information 1004 to the file name of the generated file.

In S519, the MFP 110 transmits a posting request to the chat server 130 to the MPF cooperative server 120. The posting request includes a transmission destination set in the transmission information 1004, a message to be posted, and a generated file. In S520, the MFP cooperative server 120 transmits the posting request that has been acquired from the MFP 110 to the chat server 130. Note that the connection information of the user acquired in S508 is used for the access from the MFP cooperative server 120 to the talk room serving as the posting destination of the chat server 130. In S521, the chat server 130 posts the scanned image by adding the designated message and file to the talk room of the transmission destination designated by the transmission information 1004.

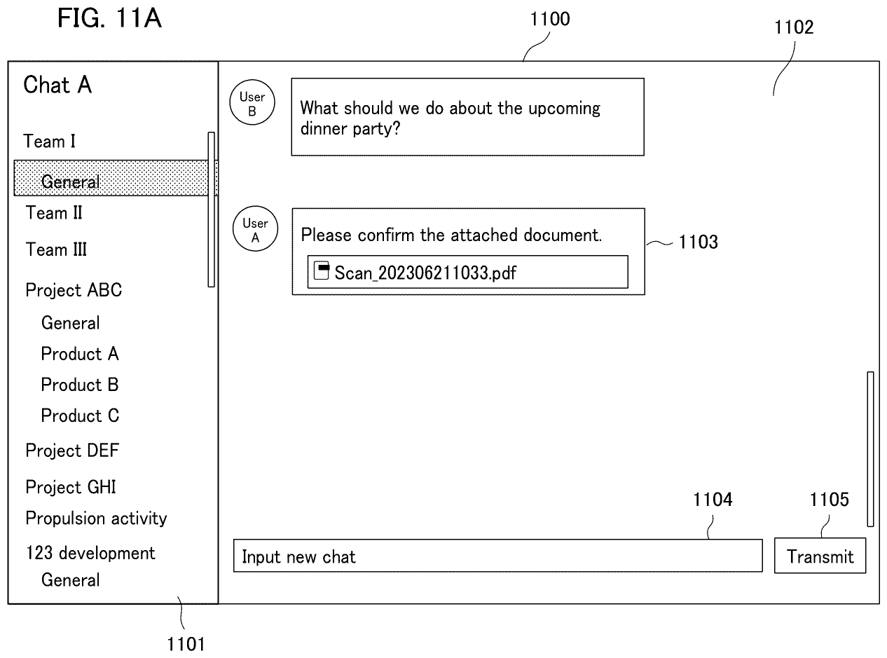

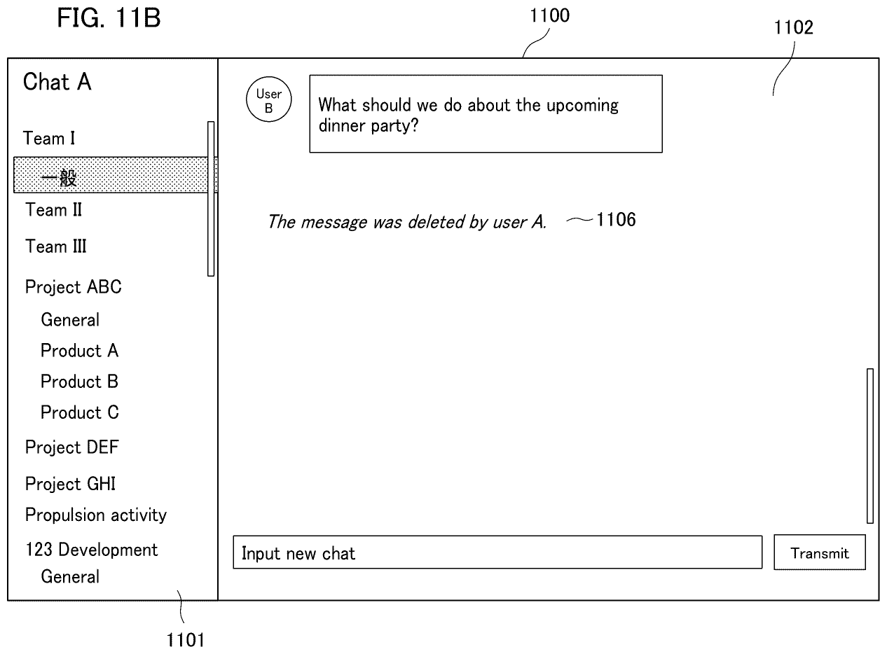

FIG. 11A to FIG. 13 are diagrams showing examples of the chat screen. A chat screen 1100 is displayed on, for example, the operation unit 317 of the client PC 111. FIG. 11A shows a chat screen in which a post of a file scanned in the MFP 110 and transmitted from the MFP 110 has been completed. The chat screen 1100 includes, for example, a chat room selection region 1101, a chat room 1102, a chat input field 1104, and a chat transmission button 1105.

The chat room selection area 1101 is a region for selecting a chat room. A list of chat room names is displayed in the chat room selection region 1101. In the chat room 1102, messages posted to the chat room that have been selected in the chat room selection region 1101 are displayed. A post message 1103 in the chat room 1102 indicates a message posted with a file attached thereto from the MFP 110 via the MFP cooperative server 120. Thus, an image scanned in the MFP 110 can be transmitted from the MFP 110 to the chat server 130, and can be posted. The chat input field 1104 is a region for a user in the PC 111 to input a chat. The chat transmission button 1105 is a button for transmitting and posting the content input in the chat input field 1104 to the chat server 130.

In S522, the chat server 130 transmits the posting result of the scanned image to the chat to the MFP cooperative server 120. In a case where the posting is successful, when the posting is completed, the chat server 130 transmits a posting ID uniquely indicating the success of the chat posting and the posting to the MFP cooperative server 120. In S523, the MFP cooperative server 120 transfers the posting result that has been received from the chat server 130 to the MFP 110.

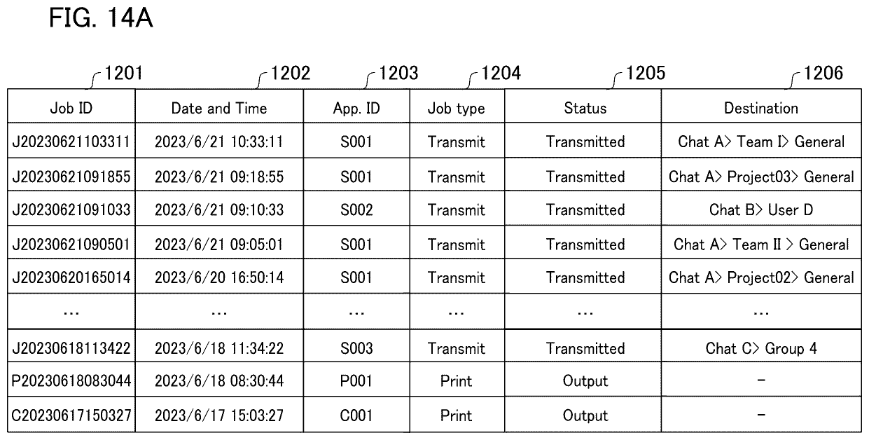

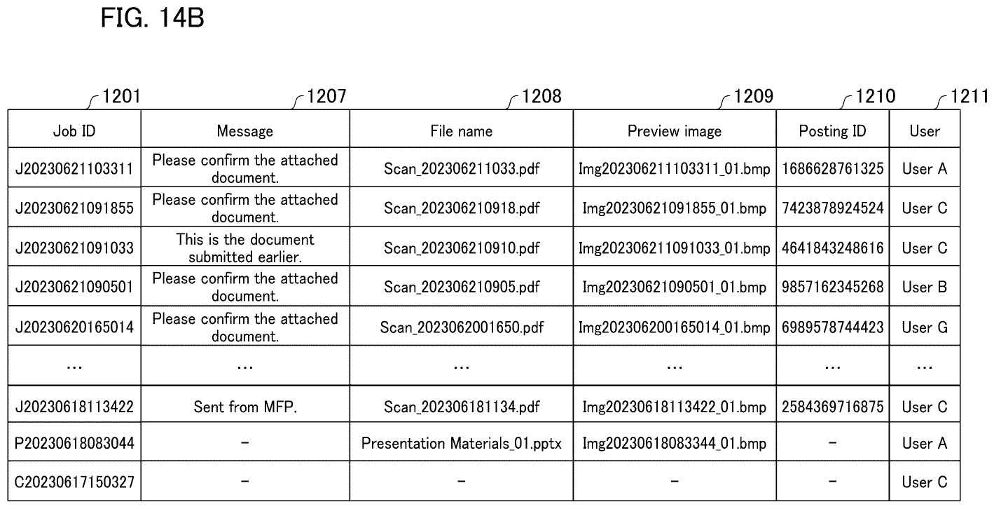

In S524, the MFP 110 adds the acquired posting result to the job history as a transmission history. FIGS. 14A and 14B are diagrams showing an example of a job history. Although the job history is divided into FIG. 14A and FIG. 14B, FIG. 14A and FIG. 14B are combined into one job history. The job history is managed by the data management unit 433 in the MFP 110. The job history includes, for example, a job ID 1201, a date and time 1202, an application ID 1203, a job type 1204, a status 1205, and a transmission destination 1206. The job history further includes a message 1207, a file name 1208, a preview image 1209, a posting ID 1210, and a user 1211.

The job ID 1201 is an ID uniquely indicating each job. The date and time 1202 are the execution date and time of the job. The application ID 1203 is the application ID of native or additional application that executed the job and are the same as the application ID 801 in FIG. 8. The job type 1204 indicates the type of the job. The type of job indicates, for example, the type of functions provided by the MFP 110, such as printing (including copying, printing, and the like) and transmission (including chat, e-mail, shared folder, facsimile, and the like).

The status 1205 indicates the status of the job. The status includes, for example, “being transmitted”, “transmitted”, “deleted”, “error”, and the like. The transmission destination 1206 is a transmission destination of the scanned image. The transmission destination 1206 includes, for example, a transmission destination, a service, a talk room, and the like. The message 1207 is a message that has been transmitted to a chat or an e-mail together with a file of the scanned image. The file name 1208 indicates a file name of the transmitted file. The preview image 1209 is a preview image of the transmitted file. In a case where the file includes a plurality of pages, the preview image 1209 holds a plurality of preview images.

The posting ID 1210 is a posting ID issued by the chat server 130. The posting ID is an ID uniquely indicating a posting of a file and a message issued by the chat server 130. The user 1211 is information indicating the user who executed the job. For example, the user 1211 may be information uniquely indicating a user, such as a user name, a user ID, and a user's mail address.

Thus, in the job history, the files and the transmission destination information transmitted to the chat server 130 in S519, the transmission results acquired from the chat server 130 in S523, and the posting IDs are stored as the transmission history in association with the job IDs. The MFP 110 adds the transmission history to the job history after the pressing of the transmission button in S517, and updates the status, the posting IDs, and the like in response to the file generation in S518 and the result of the file posting request in S523. The transmission history of the job ID “J20230621103311” as shown in FIGS. 14A and 14B″ corresponds to posting of scanned images displayed on the screens in FIG. 10A and FIG. 11A.

In S525, the MFP 110 displays a transmission completion message on the scan screen 1000. FIG. 10B is a diagram showing an example of the transmission completion message. In a case where the posting of the scanned image to the chat is successful, a completion message 1007, a history display button 1008, and a close button 1009 are displayed on the scan screen 1000. When the history display button 1008 is pressed by the user, the MFP 110 displays a screen for displaying the status and history of the job of the MFP 110, which will be described below. When the close button 1009 is pressed by the user, the MFP 110 returns the screen to be displayed to the home screen 700.

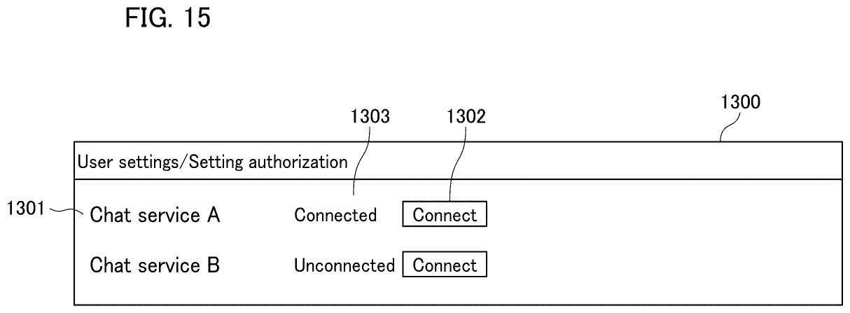

Here, a method for permitting connection between the MFP cooperative server 120 and the chat server 130 will be explained. For example, the user can log in to the MFP cooperative server 120 via, for example, the client PC111, and can display an access permission setting screen by a screen transition from a main screen (not illustrated) displayed after the login. FIG. 15 is a diagram showing an example of an access authorization setting screen. An access permission setting screen 1300 is a screen for performing settings for permitting the MFP cooperative server 120 to access the chat server 130. The access permission setting screen 1300 is provided by the MFP cooperative server 120 and displayed on the operation unit 317 of the client PC111 via the web browser.

The access permission setting screen 1300 includes a service name display area 1301, a service connection button 1302, and a service connection state display area 1303. In the service name display area 1301, the name of a chat service to which the MFP cooperative service can connect is displayed. When the service connection button 1302 is pressed, a target service authentication/authorization screen (not illustrated) is displayed, and the user can provide authorization of the target service to the MFP cooperative server 120 by performing authentication/authorization setting for the target service. The authorization setting is performed by using, for example, the mechanism of OAuth. The service connection state display area 1303 indicates whether or not connection to the service is permitted. In the service connection state display area 1303, “not connected” is displayed in a case where, for example, the connection to the service is not permitted, and “connected” is displayed in a case where, for example, the connection to the service is permitted. When the authorization setting is completed, the display of the service connection state display area 1303 is switched from “not connected” to “connected”. When the authorization setting is completed, information on the authorized service is registered in the connection service 905 of the user information table 900 corresponding to the login user. Additionally, information used to connect to a service, such as an access token acquired during authorization setting, is stored in the connection information 906 of the user information table 900 by the data management unit 433.

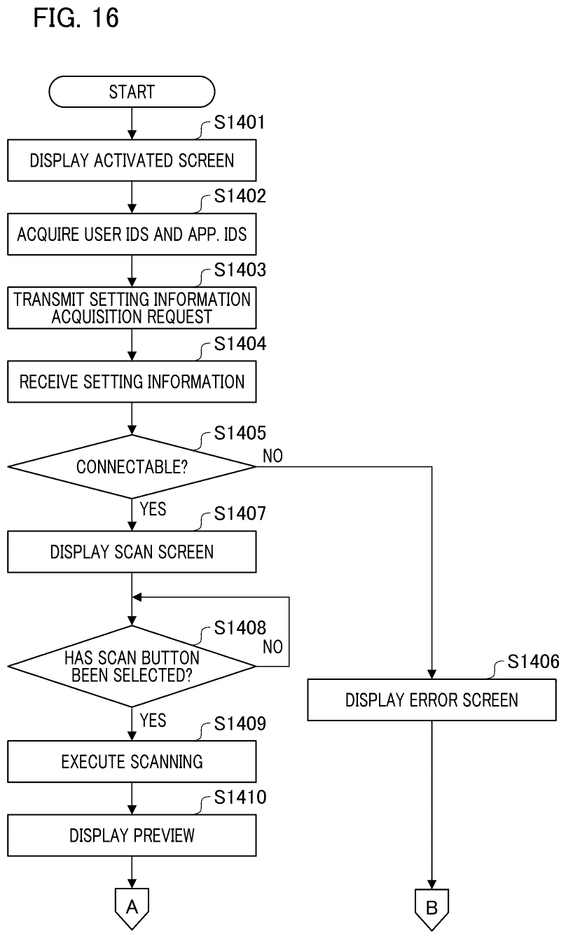

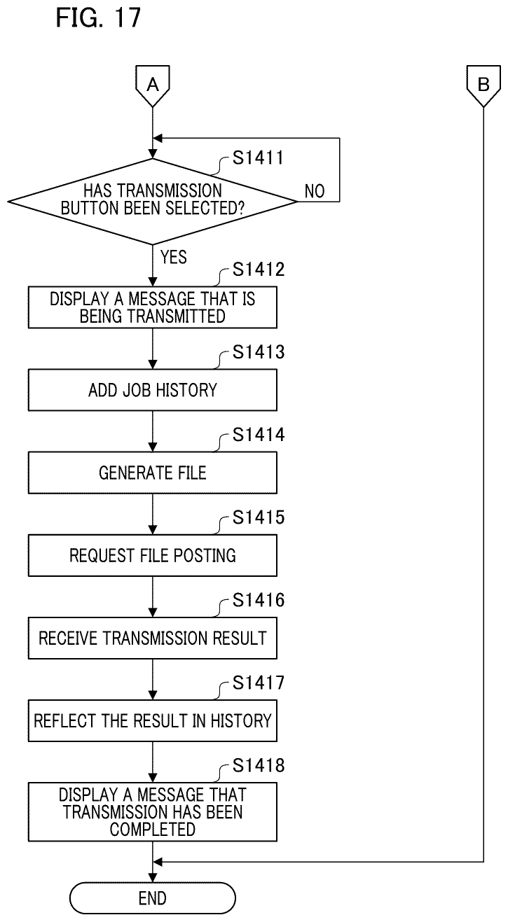

Next, scanned image posting processing performed by the MFP 110 will be explained with reference to FIG. 16 and FIG. 17. FIG. 16 and FIG. 17 are flowcharts showing the scanned image posting processing. The processes as shown in the flowcharts of FIG. 16 and FIG. 17 are processes in the MFP 110 after the pressing of the scan-to-chat button 703 by the user is detected in S505 of FIG. 5. Note that each process as shown in FIG. 16 and FIG. 17 is realized by the CPU 211 of the MFP 110 reading out a program stored in a memory (ROM 212 or HDD 214) to the RAM 213 and executing the program.

In S1401, the display control unit 421 displays, on the operation unit 220 in the MFP 110, a message (not illustrated) indicating that the application (the application of the chat service A) corresponding to the scan-to-chat button 703 pressed on the home screen 700 is being activated. In S1402, the data management unit 425 acquires the user ID of the users who are logging in and the application ID corresponding to the button pressed on the home screen 700. In the present embodiment, the data management unit 425 acquires the user ID of the logged-in user A (user 10) and the application ID of the application of the chat service A corresponding to the scan-to-chat button 703.

In S1403, the cooperative service request unit 423 transmits an acquisition request for application setting information including user IDs, application IDs, MFP serial numbers, and the like to the MFP coordinated server 120. The process in S1403 corresponds to the process in S506 of FIG. 5. In S1404, the cooperative service request unit 423 receives a response to the acquisition request for the application setting information from the MFP cooperative server 120. The cooperative service request unit 423 acquires, as a response, the application setting information (FIG. 8), a list of talk rooms accessible by the chat server 130, and information indicating whether or not the user can connect to the chat service A. Then, the data management unit 425 stores the information received from the MFP cooperative server 120 in the HDD 214.

In S1405, the display control unit 421 determines whether or not it is possible to connect to the chat service A provided by the chat server 130 based on the connectability information to the chat service A received from the MFP cooperative server 120 in S1404. If connection to the chat service A is not possible, the process of S1406 is performed. In S1406, the display control unit 421 displays an error screen indicating that connection to the chat service A is not possible. Additionally, a message corresponding to the cause of the connection failure may be displayed on the error screen. For example, in a case where the permission setting has not been performed, the MFP cooperative server 120 is separately accessed, and a message prompting permission to the chat server 130 is displayed. In contrast, in a case where connection to the chat service A is possible, the process of S1407 is performed.

In S1407, the display control unit 421 displays the scan screen 1000 in which the information received in S1404 is reflected. The application settings and the like received in the S1404 are reflected in the scan settings 1003 and the transmission information 1004. The process of S1407 corresponds to the process of S513 in FIG. 5. In S1408, the display control unit 421 determines whether or not a scan instruction has been received on the scan screen 1000. In a case where the scan button 1005 is selected, it is determined that a scan instruction has been received, and process of S1409 is performed. In contrast, it is determined that a scan instruction has not been received until the scan button 1005 is selected, and the process of S1408 is repeated.

In S1409, the scan control unit 422 instructs the scan execution unit 411 to start scanning. The scan execution unit 411 performs scan processing and generates scan image data. The scanned image data generated by scanning is stored in the scan image management unit 412, and the scan control unit 422 is notified about the corresponding scanned image identifier. During execution of the scan processing, the display control unit 421 may display a message (not illustrated) indicating that scanning is in progress.

In S1410, the image processing unit 424 generates a preview image of the scanned image. Then, the display control unit 421 displays the generated preview image 1002 on the scan screen 1000. In S1411, the display control unit 421 determines whether or not a transmission instruction has been received on the scan screen 1000. If the transmission button 1006 is selected, it is determined that a transmission instruction has been received, and the process of S1412 is performed. In contrast, until the transmission button 1006 is selected, it is determined that the transmission instruction has not been received, and the process of S1411 is repeated.

In S1412, the display control unit 421 displays a message (not illustrated) on the scan screen 1000 indicating that the scanned image is being transmitted to the chat service. In S1413, the data management unit 425 issues a job ID uniquely indicating a transmitted job, and stores information associated with the transmission as a transmission history in the job history of the HDD 214 (FIG. 14A and FIG. 14B). At this time, the status 1205 of the job history is “being transmitted”, and the posting ID 1210 is in an empty state until the transmission result is acquired.

In S1414, the image processing unit 424 converts the scanned image into a file with the file format and the file name designated in the transmission information 1004, generates the file, and stores the file in the job history of HDD 214. In S1415, the cooperative service request unit 423 transmits a file posting request to the MFP cooperative server 120 so as to transmit the file generated in S1414 to the transmission destination designated by the transmission information 1004. A message to be posted together with the file is also transmitted together with the file. The process of S1415 corresponds to the process of S519 in FIG. 5. Upon receiving the file posting request from the MFP 110, the MFP cooperative server 120 instructs the chat server 130 to post the file to the designated destination of the chat service A. The chat server 130 posts the file to the designated destination and returns a posting result including the generated posting ID to the MFP 110 via the MFP cooperative server 120. In S1416, the cooperative service request unit 423 receives the file posting result of the chat server 130 via the MFP cooperative server 120.

In S1417, the data management unit 425 reflects the file posting result received by the cooperative service request unit 423 in the job history (FIGS. 14A and 14B). At this time, the status 1205 becomes “transmitted”, and the posting ID received in the file posting result is stored in the posting ID 1210. In S1418, the display control unit 421 displays a transmission completion message on the scan screen 1000, and the process ends. FIG. 10B is a diagram showing an example of the transmission completion message. The display control unit 421 displays the completion message 1007, the history display button 1008, and the close button 1009 on the scan screen 1000. Thus, in the present embodiment, in a case where a scanned image generated in the MFP 110 is transmitted to the chat server 130 and is posted, the posting ID uniquely indicating the posting on the chat server 130 and the transmitted content can be associated with each other in the MFP 110, and can be managed as a job history.

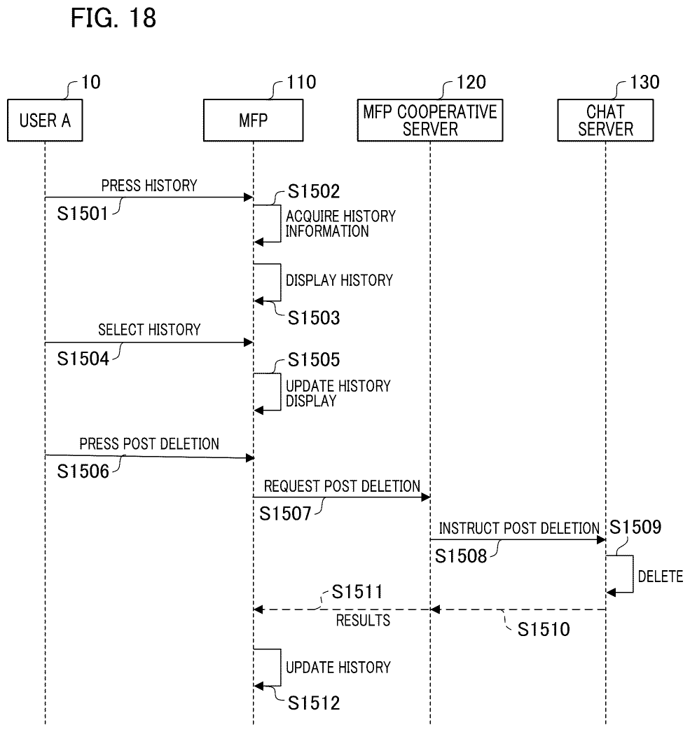

Next, a flow of processing between each device when the MFP 110 is operated to delete a post of a file and a message transmitted from the MFP 110 to the chat server 130 via the MFP cooperative server 120 will be explained. FIG. 18 is a sequence diagram showing the flow of post deletion processing. The following explanation focuses on the exchange of data between the devices. Each process executed by the MFP 110 in the post deletion processing is realized by the CPU 211 of the MFP 110 executing a program stored in a memory (ROM 212 or HDD 214). Each process executed by MFP cooperative server 120 is realized by the CPU 311 of the MFP cooperative server 120 executing a program stored in a memory (ROM 312 or HDD 314). Each process executed by the chat server 130 is realized by the CPU 311 of the chat server 130 executing a program stored in a memory (ROM 312 or HDD 314).

In S1501, the user 10 presses the history display button 1008 or the status history button 604. Thereby, the MFP 110 detects that, in S1501, the history display button 1008 or the status history button 604 has been pressed. In S1502, the MFP 110 obtains the information on the job history (FIGS. 14A and 14B) corresponding to the login user from the HDD 214. In S1503, the MFP 110 displays a history screen based on the acquired job history.

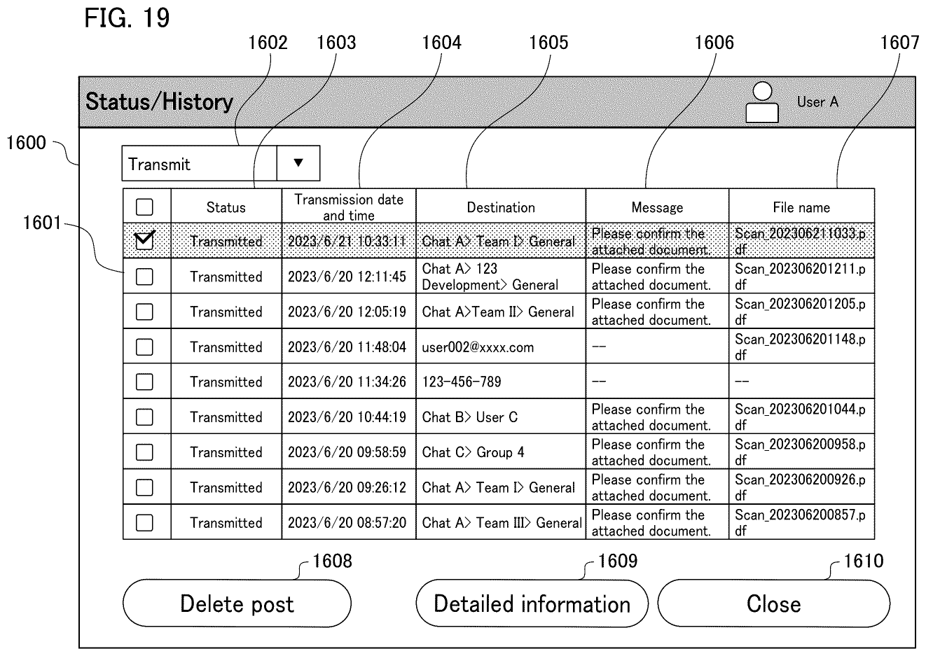

FIG. 19 to FIG. 22 are diagrams showing examples of a history screen 1600. FIG. 19 shows an example in which a list of jobs of the user who is logging in is displayed on the history screen 1600. A list of job histories of the login user A is displayed on the history screen 1600. The history screen 1600 that displays a list of jobs includes a list 1601, a switching button 1602, a post deletion button 1608, a detailed information button 1609, and a close button 1610.

The switching button 1602 is a button for switching the type of function (job) displayed in the list 1601. The switching button 1602 is, for example, a pull-down button for the user to select the type of function. In the pull-down of the switching button 1602, functions such as “print” and “transmit” are displayed in the list. The MFP 110 displays the job history corresponding to the function selected by the switching button 1602 in the list 1601.

The list 1601 is a list for displaying the list of jobs executed by the user. The list 1601 displays a list of job histories corresponding to the function selected by the switching button 1602. In the example as shown in FIG. 19, “transmit” indicating a job to be scanned and transmitted is selected in the switching button 1602, and a list screen of a transmission history is displayed in the list 1601.

The transmission job list 1601 includes, for example, a status 1603, a transmission date and time 1604, a transmission destination 1605, a message 1606, and a file name 1607 as items. The status 1603 displays the status of the job. The status 1603 is information corresponding to the status 1205 of the job history as shown in FIG. 14A. The transmission date and time 1604 displays the execution date and time of the job. The transmission date and time 1604 is information corresponding to the date and time 1202 of the job history as shown in FIG. 14A. The transmission destination 1605 displays the transmission destination of the job. The transmission destination 1605 is information corresponding to the transmission destination 1206 of the job history as shown in FIG. 14A. The message 1606 displays the content of a message transmitted from the chat server 130 and by e-mail. The message 1606 is information corresponding to the message 1207 of the job history as shown in FIG. 14B. The file name 1607 displays the file name of the transmitted file. The file name 1607 corresponds to the file name 1208 of the job history as shown in FIG. 14B.

The post deletion button 1608 is a button for deleting posting corresponding to the history of the transmission job selected in the list 1601. The post deletion button 1608 is displayed in a pressable state in a case where the post deletion function can be used for the history of the transmission job selected in the list 1601. In the present embodiment, in a case where the job history selected from the list 1601 is a job for the chat server 130 and the post deletion function can be used, this button is displayed in a pressable state. The close button 1610 is a button for closing the history screen 1600.

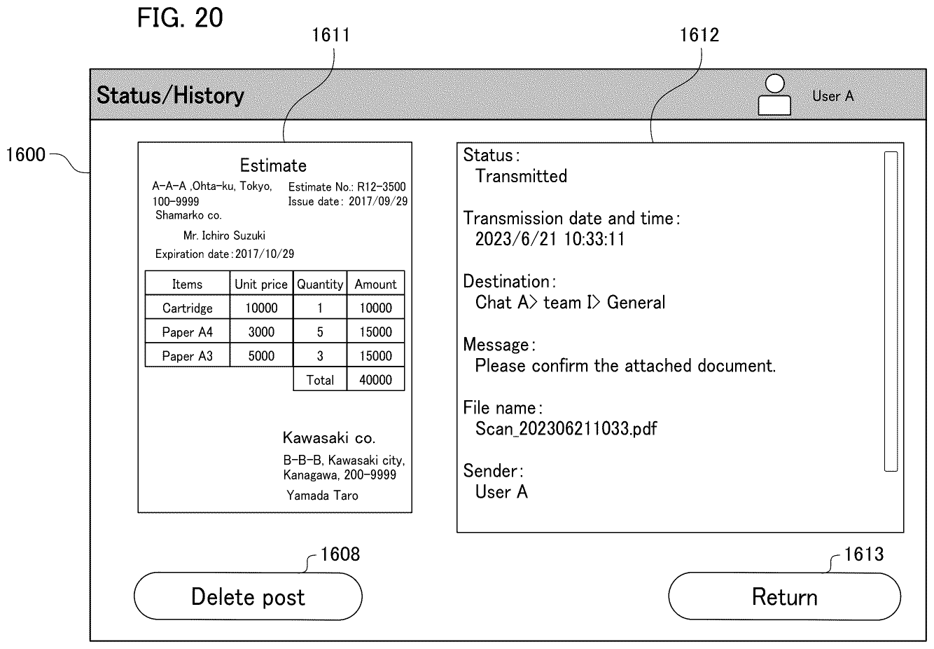

The detailed information button 1609 is a button for displaying detailed information of the selected job. Upon detecting that the detailed information button 1609 has been pressed, the MFP 110 displays a detailed information screen of the job on the history screen 1600. FIG. 20 is a diagram showing an example of the detailed information screen of the transmission job. On the detailed information screen, a preview image 1611 and detailed information 1612 about a job are displayed. The preview image 1611 is a preview image of a file that has been transmitted by the transmission job. In the preview image 1611, an image held in the preview image 1209 of the job history as shown in FIG. 14B is displayed. In the job detailed information 1612, in addition to the information displayed in the list 1601, information included in the job history of the job history as shown in FIG. 14A and FIG. 14B, such as information on the sender, is displayed.

Additionally, a post deletion button 1608 and a return button 1613 are displayed on the detailed information screen of the job. The post deletion button 1608 is displayed in a selectable manner only in a case where the job history displayed on the detailed information screen of the job is a job history corresponding to post deletion. The return button 1613 is a button for closing the detailed information screen of the job and returning to the history screen 1600. Thus, it is possible to display information that cannot be displayed on the history screen 1600 on the detailed information screen, and it is possible to improve convenience when the user confirms whether or not the posting is incorrect. In a case where the user determines that the posting should be deleted in a case where, for example, the posting is incorrect, the user presses the post deletion button 1608.

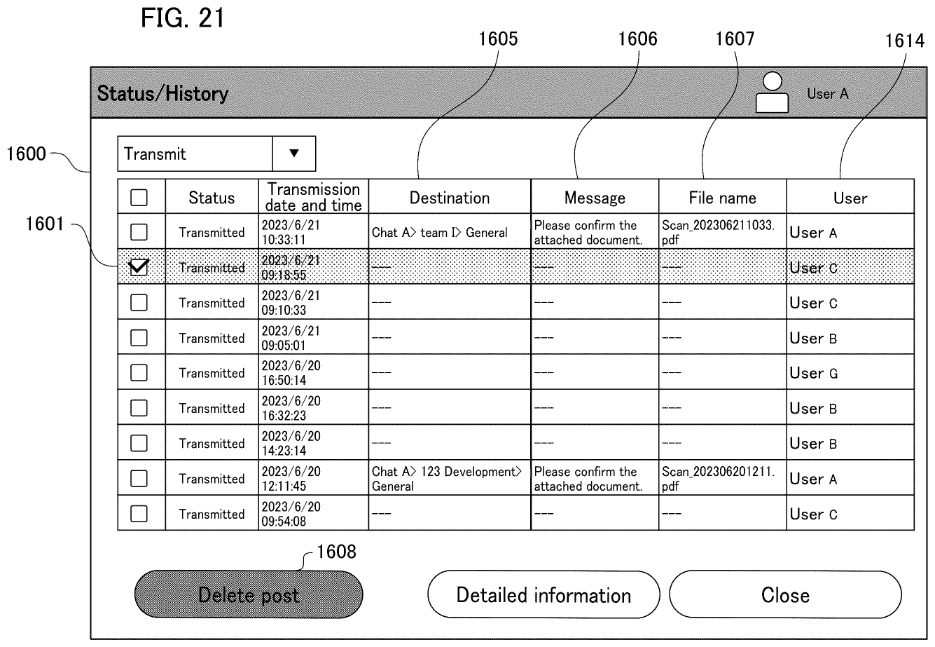

Although, in FIG. 19, an example is shown in which only the job history of the user A who is logging in is displayed, the present invention is not limited thereto. As shown in FIG. 21, even when the user A is logging in, job histories of the other users (for example, the user B and the user C) may also be displayed. FIG. 21 shows an example in which a list of jobs of a plurality of users is displayed on the history screen 1600. In a case where the history of a user other than the user who is logging in is also displayed, a user 1614 of the item indicating the name of the user who instructed the execution of the job is also displayed in the list 1601. The user 1614 is information corresponding to the user 1211 of the job history as shown in FIG. 14B. Additionally, the transmission destination 1605, the message 1606, the file name 1607, and the like are not displayed in the job history of a user other than the login user. Additionally, in a case where the job history of a user other than the user who is logging in is selected and the detailed information button 1609 is pressed, the preview image 1611 of the detailed information screen is also not displayed. Additionally, a job for which a user who is logging in can delete a post is limited to his/her own job, and while another user is selecting a job history, the post deletion button 1608 cannot be selected even for a job history for which the post deletion function can be used. In a state where the post deletion button 1608 cannot be selected, the post deletion button 1608 is displayed in a grayed-out manner. Note that in a state in which the post deletion button 1608 cannot be selected, the post deletion button 1608 need not be displayed.

The explanation returns to FIG. 18. In S1504, the user selects one job history from the list 1601. Thereby, in S1504, the MFP 110 detects that the user has selected the job history. In S1505, the MFP 110 updates the display of the post deletion button 1608 on the history screen 1600 according to the selected job history. Specifically, the MFP 110 first refers to the status 1205 and the transmission destination 1206 corresponding to the selected job history. In a case where the transmission destination 1206 is not a chat service, for example, in a case of a destination that cannot be deleted, such as an e-mail address and a fax, the post deletion button 1608 is disabled and displayed on the history screen 1600 in a state in which the button cannot be pressed (for example, grayed out). In a case where the status 1205 is “transmitted” and the transmission destination 1206 is chat service, the MFP 110 further acquires the application ID 1203. Then, the MFP 110 refers to the setting information (post deletion 808) of the application setting information (FIG. 8) that has been acquired in the past by the setting acquiring request in S506 and the like and stored in the HDD 214, and determines whether or not the application ID corresponding to the job history corresponds to post deletion. In a case where the post deletion 808 is “True”, the MFP 110 enables the post deletion button 1608 and displays it on the history screen 1600 in a pressable state. In contrast, in a case where the post deletion 808 is “False”, the MFP 110 disables the post deletion button 1608 and displays it on the history screen 1600 in a non-selectable state.

In a case where the user deletes the posting corresponding to the job history selected in step S1504, the user presses the post deletion button 1608 in step S1506. Thereby, in S1506, the MFP 110 detects the pressing of the post deletion button 1608. In S1507, the MFP 110 transmits a post deletion request to the MFP cooperative server 120 together with the information on the posting ID 1210 corresponding to the selected job history.

In S1508, the MFP cooperative server 120 transmits a post deletion instruction to the chat server 130 together with the posting ID that has been received from the MFP 110. In S1509, the chat server 130 deletes messages and files related to the received posting ID. FIG. 11B is a diagram showing an example of the chat screen in which the posting has been deleted. On the chat screen 1100, the post message 1103 as shown in FIG. 11A is deleted, and a message 1106 indicating that the posting has been deleted is displayed.

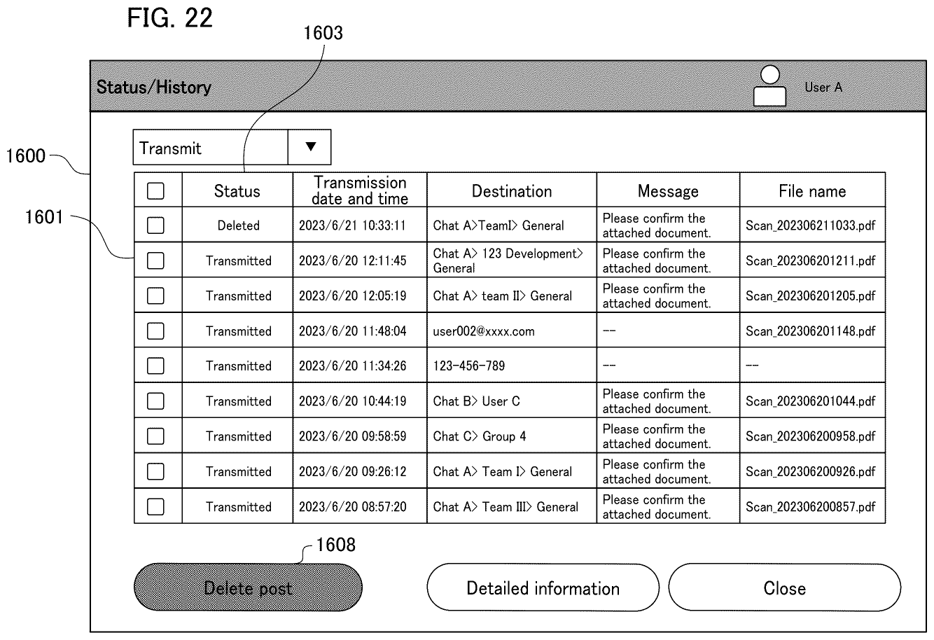

In S1510, the chat server 130 transmits the result of the post deletion to the MFP cooperative server 120. In S1511, the MFP cooperative server 120 transmits the result of the post deletion received from the chat server 130 to the MFP 110. The MFP 110 receives the result of the post deletion from the chat server 130 via the MFP cooperative server 120. In the present embodiment, it is assumed that the post deletion has succeeded, and the MFP 110 has received a result indicating that the post deletion has succeeded. In a case where the post deletion has succeeded, in S1512, the MFP 110 updates the status of the history corresponding to the job history in which the post deletion has been executed to “deleted”. That is, the status 1205 corresponding to the job ID for which the posting has been deleted in the job history (FIG. 14A and FIG. 14B) is changed to “deleted”. The change in the status 1205 of the job history is reflected in the status 1603 of the list 1601 displayed on the history screen 1600. FIG. 22 is a diagram illustrating an example of a history screen after the execution of deletion. Comparing FIG. 19 and FIG. 22, it can be understood that the status 1603 of the job selected in FIG. 19 has been changed from “transmitted” to “deleted”.

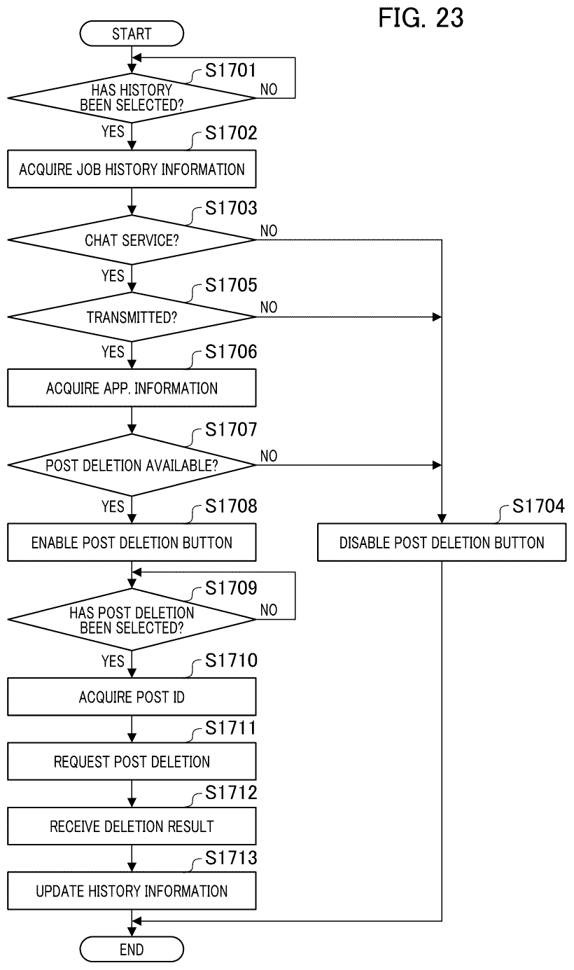

Next, details of the processing of the MFP 110 in the post deletion processing that has been explained in FIG. 18 will be explained with reference to FIG. 23. FIG. 23 is a flowchart showing the post deletion processing. The process as shown in the flowchart of FIG. 23 is a process in the MFP 110 after the history is displayed in S1503 of FIG. 18. Note that each process as illustrated in FIG. 23 is realized by the CPU 211 in the MFP 110 reading out a program stored in a memory (ROM 212 or HDD 214) to the RAM 213, and executing the program.

In step S1701, the display control unit 421 determines whether or not a job history has been selected in the list 1601. In a case where it is determined that a job history has been selected, the MFP 110 performs the process of S1702. In contrast, the MFP 110 repeats the process of S1701 until it is determined that a job history has been selected.

The MFP 110 determines whether to enable or disable the display of the post deletion button 1608 of the history screen 1600 in the processes of S1702 to S1707. In a case where the posting cannot be deleted, the MFP 110 disables the display of the post deletion button 1608 on the history screen 1600, and only in a case where the posting can be deleted, the MFP 110 enables the display of the post deletion button 1608. The MFP 110 determines whether or not the post deletion can be performed, that is, whether or not the display of the post deletion button 1608 of the history screen 1600 is enabled based on the information on the job history and the application setting information.

In S1702, the data management unit 425 acquires information corresponding to the job history selected in the list 1601 from the job history (FIGS. 14A and 14B). In S1702, the data management unit 425 acquires information including at least the application ID1203, the status 1205, and the transmission destination 1206 as information corresponding to the selected job history.

In S1703, the display control unit 421 refers to the information on the job history acquired in S1702, and determines whether or not the transmission destination 1206 is a chat service. In a case where the transmission destination 1206 is a chat service, the MFP 110 performs the process of S1705. In contrast, in a case where the transmission destination 1206 is not a chat service, since the post deletion cannot be performed, the MFP 110 performs the process of S1704. In S1704, the display control unit 421 disables the display of the post deletion button 1608 on the history screen 1600, and the present processing ends. The display control unit 421 displays the post deletion button 1608 in a disabled state by graying out the post deletion button 1608 so that the post deletion button 1608 cannot be pressed.

In S1705, the display control unit 421 refers to the information on the job history that has been acquired by the data management unit 425, and determines whether or not the status 1205 is “transmitted”. In a case where the status 1205 is “transmitted”, the MFP 110 performs the process of S1706. In contrast, in a case where the status 1205 is not “transmitted”, since the post deletion cannot be used, due to, for example, being transmitted, deleted, or an error, the MFP 110 performs the process of S1704. In S1704, the display control unit 421 disables the display of the post deletion button 1608, and the processing ends.

In S1706, the data management unit 425 acquires application information corresponding to the application ID 1203 of the job history from the HDD 214. Here, the application information held by the HDD 214 is the same as the application setting information (FIG. 8) held by the MFP cooperative server 120. The application information can be acquired from the MFP cooperative server 120 by the process of S512, and, in addition to this, the latest state may be maintained by periodically synchronizing the MFP 110 and the MFP cooperative server 120. In S1706, the data management unit 425 acquires information including at least the post deletion 808 as application information.

In S1707, the display control unit 421 determines whether or not post deletion is possible. Whether or not posting can be deleted is determined based on whether or not the chat service has a post deletion function, that is, whether or not the post deletion 808 of the application information acquired by the data management unit 425 is “True” or “False”. If the post deletion 808 is “True”, it is determined that post deletion is possible, and the MFP 110 performs the process of S1708. In contrast, in a case where the post deletion 808 is “False”, post deletion cannot be used, and therefore the MFP 110 performs the process of S1704. In S1704, the display control unit 421 disables the display of the post deletion button 1608, and the present processing ends.

In S1708, the display control unit 421 enables the display of the post deletion button 1608 of the history screen 1600. In S1709, the display control unit 421 determines whether or not the post deletion button 1608 has been selected. In a case where it is determined that the post deletion button 1608 has been selected, the MFP 110 performs the process of S1710. In contrast, the MFP 110 repeats the process of S1709 until the post deletion button 1608 is selected. Note that in a case where it is detected that a button other than the post deletion button 1608 has been selected, the MFP 110 executes a process corresponding to the selected button.

In S1710, the data management unit 425 acquires the posting ID 1210 of the job for which post deletion has been instructed, from the job history (FIG. 14A and FIG. 14B). In S1711, the cooperative service request unit 423 transmits a request to delete a file and a message related to the posting ID together with the posting ID 1210 acquired by the data management unit 425, to the MFP cooperative server 120. Upon receiving the post deletion request from the MFP 110, the MFP cooperative server 120 transmits a request to delete a file and a message related to the posting ID 1210 together with the received posting ID, to the chat server 130. Upon receiving the post deletion request from the MFP 110 via the MFP cooperative server 120, the chat server 130 deletes the file and message related to the posting ID based on the received posting ID 1210. Then, the chat server 130 transmits the result of the post deletion to the MFP 110 via the MFP cooperative server 120.

In S1712, the cooperative service request unit 423 receives the post deletion result of the chat server 130 via the MFP cooperative server 120. In S1713, the data management unit 425 updates the status 1205 of the job history (FIG. 14A and FIG. 14B) based on the post deletion result received by the cooperative service request unit 423. For example, in a case where the post deletion result is successful, the data management unit 425 changes the status 1205 from “transmitted” to “deleted”. Then, the display control unit 421 updates the display of the status 1603 in the list 1601 on the history screen 1600 according to the job history updated by the data management unit 425.

Thus, by managing the posting ID uniquely indicating the postings on the chat server 130 and the job history in association with each other in the MFP 110, it is possible to delete the file and message of the chat server 130 related to the job selected in the list 1601. As a result, it is possible for the user to delete a file that has been erroneously transmitted to the chat server 130 by operating the operation unit 220 of the MFP 110. Examples of the erroneous transmission by the user include an error of a scanned original such as an entry defect of an original or excess or deficiency of a page, an error of transmission information such as a selection error of a talk room of a transmission destination, and an error of scan setting. In the case of a chat, there is a high possibility that the member of the talk room who has transmitted the file views or acquires the file immediately after receiving a notification that a new posting has been made. Therefore, it is necessary to delete a file or correct an error as soon as an error occurs in a more important original. Therefore, deleting a post transmitted from the MFP 110, which is a terminal that has executed the transmission process, to the chat server 130 enables deletion of a post in the shortest time as compared to a case where a post is moved to another terminal and deleted, and thus improves user convenience.

Although, in the post deletion processing illustrated in FIG. 23, the determinations in S1703, S1705, and S1707 has been described as the switching condition of the enable/disable display of the post deletion button 1608, a time elapsed since the job execution time may be further added to the determination. In a case where the time elapsed since the job execution time is used as the switching condition of the enable/disable display of the post deletion button 1608, the date and time 1202 is also acquired when the job history is acquired in the S1702. For example, in a case where “transmitted” is determined in S1705, the display control unit 421 performs the processing of determining whether or not an arbitrary time has elapsed since the transmission date and time 1202. The arbitrary time can be set by the MFP 110 or the MFP cooperative server 120. In a case where the predetermined time has elapsed, the display control unit 421 performs the process of S1704, and disables the display of the post deletion button 1608. In contrast, in a case where the arbitrary time has not elapsed, the MFP 110 performs the process of S1706. In the present embodiment, a main case where the user wants to execute deleting the post by operating the MFP 110 is a case where the user notices a mistake immediately after the operation of transmission. Thereby, it is unlikely that old posts are intentionally deleted from the MFP 110. By disabling the display of the post deletion button 1608 after an arbitrary time has elapsed, it is possible to prevent the user from erroneously deleting the posting of an old job history.

Next, the processing in a case where posting cannot be deleted will be explained. Even if the post deletion processing (FIG. 23) is performed, the posting cannot be deleted in the case of a chat service in which the post deletion function is not supported. In the present embodiment, in a case where the posting cannot be deleted, a correction message indicating that the transmitted file is erroneous is posted, thereby providing a notification that the file transmitted to the talk room is erroneously transmitted to the other users of the chat. If a post is sent to the chat room to provide notification that the file transmitted to the talk room was erroneously transmitted, it is possible to prompt the other users to stop viewing and acquiring the wrong file.

Even in a chat service corresponding to post deletion, there is a case where another user downloads a file to be deleted before a post is deleted. In the present embodiment, in a case where another user has already downloaded the file to be deleted, another user of the chat is provided notification that the file transmitted to the talk room has been erroneously transmitted by posting a correction message indicating that the transmitted file is erroneous. If a message indicating that the file transmitted to the talk room has been erroneously transmitted is posted, it is possible to prompt the other users to stop viewing the file that has been already downloaded and delete the file.

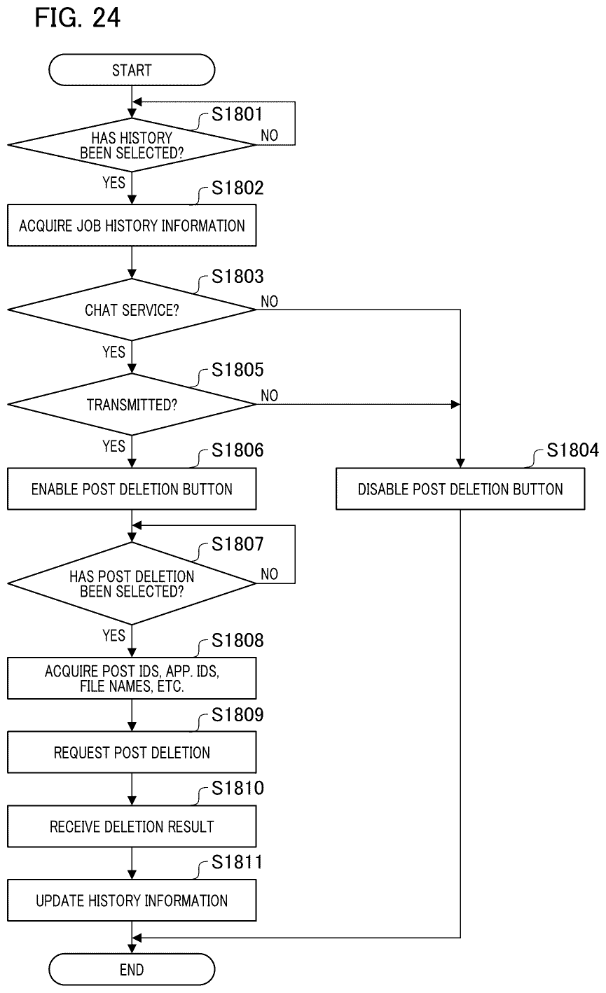

FIG. 24 is a flowchart showing the post deletion processing in the MFP 110. The processes as shown in the flowchart of FIG. 24 are the processes in the MFP 110 after the history is displayed in S1503 of FIG. 18. Note that each process illustrated in FIG. 24 is realized by the CPU 211 in the MFP 110 reading out a program stored in a memory (ROM 212 or HDD 214) to the RAM 213, and executing the program.

The processes from S1801 to S1805 in FIG. 24 are similar to those from S1701 to S1705 in FIG. 23. If it is determined in S1805 that the status of the job history selected in S1801 is “transmitted”, the MFP 110 performs the process of S1806. In S1806, the display control unit 421 enables the display of the post deletion button 1608 of the history screen 1600. That is, in this processing, the display of the post deletion button 1608 is enabled, regardless of whether or not the selected job history corresponds to post deletion.

In S1807, the display control unit 421 determines whether or not the post deletion button 1608 has been selected. In a case where it is determined that the post deletion button 1608 has been selected, the MFP 110 performs the process of S1808. In contrast, the MFP 110 repeats the process of S1807 until the post deletion button 1608 is selected. In S1808, the data management unit 425 acquires information on the job for which the post deletion has been instructed from the job history (FIG. 14A and FIG. 14B). The job information acquired by the data management unit 425 in S1808 includes at least the posting ID 1210, the application ID 1203, and the file name 1208.

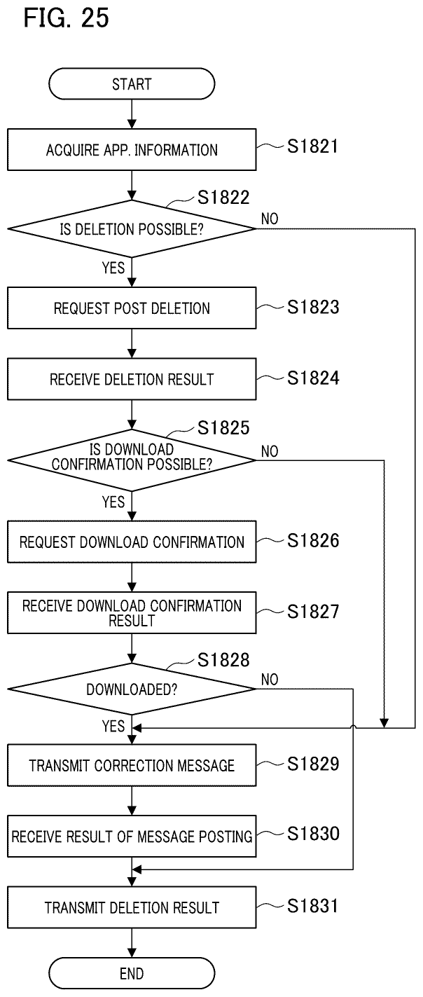

In S1809, the cooperative service request unit 423 transmits a request to delete a file and a message related to the posting ID together with the posting ID 1210 acquired by the data management unit 425, to the MFP cooperative server 120. The MFP cooperative server 120 that has received the post deletion request from the MFP 110 performs the processes as shown in FIG. 25. FIG. 25 is a flowchart showing the post deletion processing in an MFP cooperative server 120. The MFP cooperative server 120 transmits a post deletion request to the chat server 130 in a case where the posting can be deleted and transmits a posting request for a correction message to the chat server 200 in a case where the posting cannot be deleted. Each process as shown in FIG. 25 is realized by the CPU 311 of the MFP cooperative server 120 reading out a program stored in the memory (ROM 312 or HDD 314) to the RAM 213, and executing the program.

In S1821, the data management unit 433 acquires application information corresponding to the application ID 1203 received from the MFP 110 from the application setting information (FIG. 8) held by the HDD 314. In S1821, the data management unit 433 acquires information including at least the post deletion 808 and the download confirmation 809 as application information.

In S1822, the external server access unit 432 determines whether or not the post deletion function can be used in the application based on the post deletion 808 acquired in S1821. In a case where the post deletion 808 is “True”, the MFP cooperative server 120 determines that the post deletion function of the application can be used and performs the process of S1823. In contrast, in a case where the post deletion 808 is “False”, it is determined that the post deletion function of the application cannot be used, and the MFP cooperative server 120 performs the process of S1829.

In S1823, the external server access unit 432 transmits a request to delete the posting of the file and the message related to the posting ID to the chat server 130. The chat server 130 that has received the post deletion request from the MFP cooperative server 120 deletes the posting of the file and the message corresponding to the posting ID. At this time, the chat screen 1100 becomes the display as shown in FIG. 11B as described above. Then, the chat server 130 transmits a result of the post deletion process to the MFP cooperative server 120. In S1824, the external server access unit 432 receives the result of deletion from the chat server 130.

In S1825, based on the download confirmation 809 acquired in S1821, the external server access unit 432 determines whether or not it is possible to confirm whether or not a file corresponding to the posting ID that has been received from the MFP 110 has already been downloaded from the chat. In a case where the download confirmation 809 is “True”, it is determined that download confirmation is possible, and the MFP cooperative server 120 performs the process of S1826. In contrast, in a case where the download confirmation 809 is “False”, the MFP cooperative server 120 determines that the download confirmation is impossible and performs the process of S1829.

In S1826, the external server access unit 432 transmits a request to confirm whether or not a file corresponding to the posting ID has been downloaded to the chat server 130. In the case of a chat service capable of acquiring the presence or absence of a user who has downloaded, the download confirmation request is transmitted to determine whether or not there is a user who has downloaded. The chat server 130 that has received the download confirmation request confirms whether or not there is a user who has downloaded the file corresponding to the posting ID and returns a confirmation result to the MFP cooperative server 120.

In S1827, the external server access unit 432 receives the download confirmation result from the chat server 130. In S1828, the external server access unit 432 determines the presence or absence of a user who has completed a download based on the download confirmation result received from the chat server 130. In a case where there is a user who has completed a download, the MFP cooperative server 120 performs the process of S1829. In contrast, in a case where there is no user who has completed a download, the process of S1831 is performed.

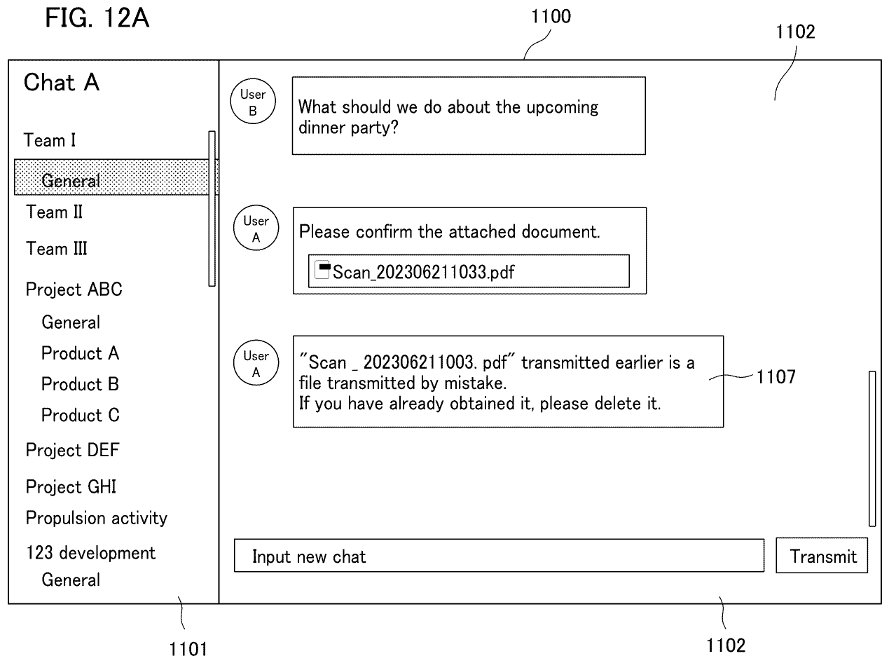

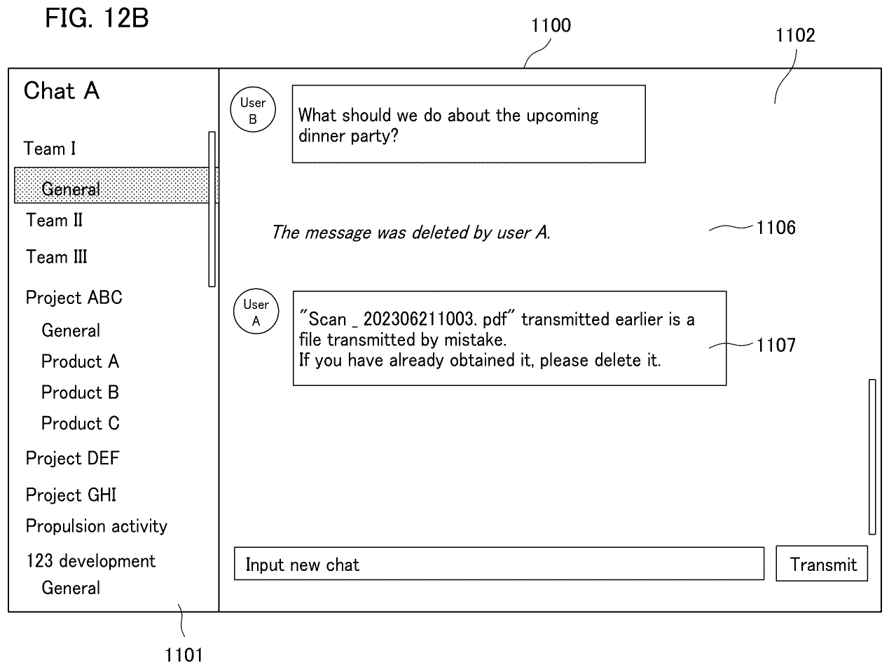

In S1829, the external server access unit 432 transmits a posting request for a correction message together with the posting ID to the chat server 130. The chat server 130 that has received the posting request of the correction message from the MFP cooperative server 120 performs the processing of posting a correction message to the chat room in which the posting corresponding to the posting ID has been performed. The correction message is a message indicating that the posting has been erroneously transmitted. Additionally, the correction message may include a message requesting deletion of the file in a case where the file has been downloaded. FIG. 12A and FIG. 12B are diagrams showing an example of a chat screen on which a correction message is posted. For example, a message that the file has been transmitted by mistake to the members of the talk room and a message prompting the members to delete the acquired file are displayed in the correction message 1107.

FIG. 12A is an example of the chat screen 1100 in which the selected post is not deleted, and a correction message is posted. If it is determined in S1822 that the posting cannot be deleted (S1822-NO), the chat screen 1100 as shown in FIG. 12A is displayed. FIG. 12B is an example of the chat screen 1100 in which the selected post is deleted, and a correction message is posted. In a case where it is determined in S1822 that post cannot be deleted (S1822-YES), and in a case where it is not determined that there is no user who has downloaded the file (S1828-YES), the chat screen 1100 as shown in FIG. 12B is obtained. That is, in a case where the post is deleted and the download confirmation is impossible, and in a case where the post is deleted and the download confirmation is possible and it is confirmed that the user has downloaded the posted file, the chat screen 1100 as shown in FIG. 12B is displayed. In a case where the posting is deleted and there is no user who has completed the download, it is not necessary to prompt the deletion, and therefore, the transmission of the correction message (S1829) is not performed.

In addition, when the posting processing of the correction message is completed, the chat server 130 transmits the posting result of the correction message to the MFP cooperative server 120. In S1830, the external server access unit 432 receives the posting result of the correction message from the chat server 130. In S1830, the external server access unit 432 receives the posting result of the correction message from the chat server 130. In S1831, the request control unit 431 transmits the execution result for the deletion instruction from the MFP 110 to the MFP 110. The execution result includes information indicating whether “post deletion” or “posting of correction message” has been executed.

The explanation returns to the flow of FIG. 24. In S1810, the cooperative service request unit 423 in the MFP 110 receives the execution result for the deletion request from the MFP cooperative server 120. The execution result received in S1810 is the execution result transmitted by the MFP cooperative server 120 in S1831. In S1811, the data management unit 425 updates the status 1205 of the job history (FIGS. 14A and 14B) based on the result received in S1810. For example, in a case where only transmission of a message prompting deletion has been performed, the status 1205 becomes “correction message has been transmitted”. Then, the display control unit 421 changes the display of the status 1205 of the list 1601 of the history screen 1600 according to the update of the status 1603 and displays it.

As described above, even in a case where there is a possibility that there is a chat service in which a posting cannot be deleted or a user who has already completed downloading a file, it is possible to inhibit a wrong file from being viewed or acquired by transmitting a correction message that prompts the deletion. Additionally, even in a case where the posting can be deleted, if the file instructed to be deleted has already been downloaded by another user, it is possible to inhibit a wrong file from being viewed by transmitting a correction message that prompts the deletion.

As described above, according to the present embodiment, posting of a file and a message on the chat service corresponding to the job history selected on the transmission history screen of the image processing apparatus can be deleted by operating the image processing apparatus. Consequently, in a case where a message or a file is erroneously transmitted from the image processing apparatus to the chat service, an instruction to delete the post can be immediately provided from the image processing apparatus, without using another terminal.

### Second Embodiment

In the first embodiment, an example has been explained in which an account of a user who uses the chat server 130 is used to transmit a file or a message from the MFP cooperative server 120 to the chat server 130. In the second embodiment, an example of using an account for chatbot associated with the MFP 110 will be explained. The account for chatbot is generated on the chat server 130 by a provider of the additional application of the MFP 110 or an administrator of the chat server 130. In the present embodiment, an explanation will be given on the assumption that settings necessary for communication between the MFP cooperative server 120 and the chat server 130 by the account dedicated to chatbot have been set in advance by the additional application provider or the administrator. Note that, in the second embodiment, only differences from the first embodiment will be explained, and portions that are not particularly specified have the same configurations and procedures as those in the first embodiment.

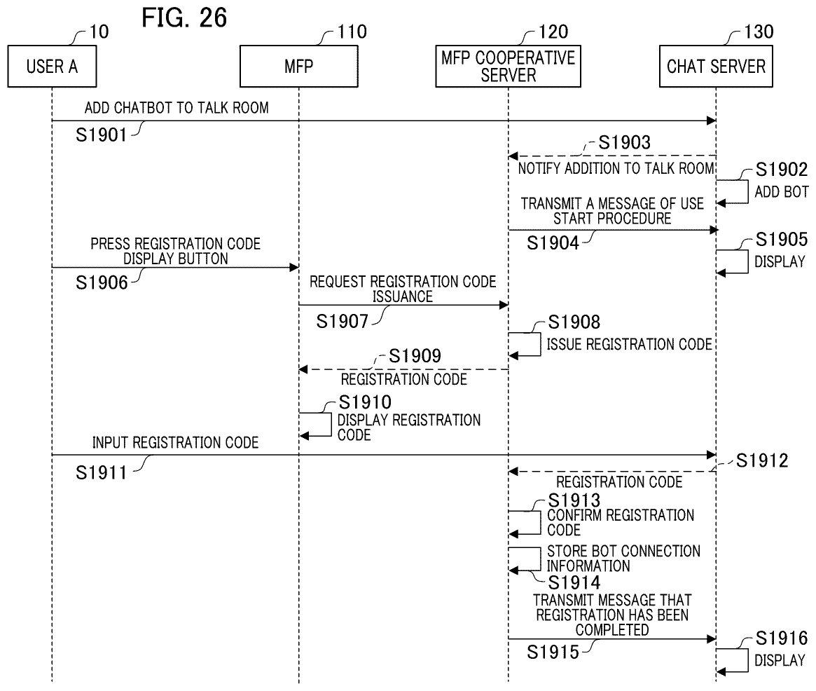

FIG. 26 is a sequence diagram showing the flow of chatbot account registration processing. In FIG. 26, a processing flow between each device until settings are made so that an image scanned in the MFP 110 can be transmitted to the chat server 130 with the account of the chatbot is shown. Each process executed by the MFP 110 is realized by the CPU 211 of the MFP 110 executing a program stored in a memory (the ROM 212 or the HDD 214). Each process executed by MFP cooperative server 120 is realized by the CPU 311 of the MFP cooperative server 120 executing a program stored in a memory (ROM 312 or HDD 314). Each process executed by the chat server 130 is realized by the CPU 311 of the chat server 130 executing a program stored in a memory (ROM 312 or HDD 314).

The user logs in to the chat server 130 in advance via the client PC 111 and the like. In S1901, the user provides an instruction to add the account of the chatbot created by the provider of the additional application or the administrator to the talk room in the MFP 110 where the user wants to use scan-to-chat. Thereby, the chat server 130 receives an instruction to add a chatbot account to the talk room from the user. In S1902, the chat server 130 performs the processing of adding the chatbot to the talk room. In S1903, the chat server 130 provides a notification about the addition of the chatbot together with information on the added talk room to the MFP cooperative server 120.

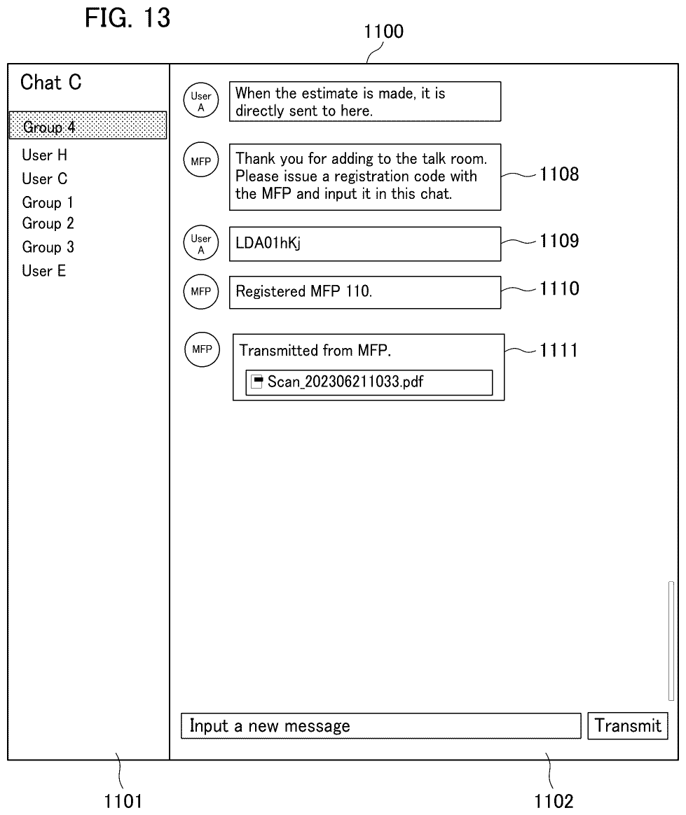

In S1904, the MFP cooperative server 120 transmits a message indicating a procedure necessary until the start of use to the talk room that has been received from the chat server 130. In S1905, the chat server 130 posts the message received from MFP cooperative server 120 to the chat room. FIG. 13 is an example of the posting screen on which the message indicating the procedure necessary for starting the use transmitted by the MFP cooperative server 120 is displayed. On the chat screen 1100, a message 1108 indicating the procedure necessary for the start of use that has been transmitted by the MFP cooperative server 120 is displayed. For example, a message indicating that it is necessary to input a registration code displayed on the MFP 110 in this talk room for beginning use is displayed on the message 1108.

S1906 to S1910 are processes for acquiring a registration code supported by S1905. In S1906, the user operates the MFP 110 to press a registration code display button (not illustrated) of the application that the user is going to use. Thus, the MFP 110 detects the pressing of the registration code display button. In S1907, the MFP 110 transmits a registration code issuance request to the MFP cooperative server 120 together with the serial number uniquely indicating the MFP 110 and the application ID of the application that the user is going to use. In S1908, the MFP cooperative server 120 issues the registration code in response to the issuance request of the registration code, and stores the registration code in association with the serial number of the MFP 110 and the application ID. In S1909, the MFP cooperative server 120 transmits the issued registration code to the MFP 110. In S1910, the MFP 110 displays the registration code on the operation unit 220.

In S1911, the user inputs the registration code displayed in the MFP 110 in the talk room. Thereby, the chat server 130 displays the registration code input by the user on the chat screen 1100. A message 1109 as shown in FIG. 13 is an example of the registration code input by the user. In S1912, the chat server 130 transmits the input registration code to the MFP cooperative server 120.

In S1913, the MFP cooperative server 120 confirms the serial number and the application ID of the MFP 110 that matches the registration code received from the chat server 130. Then, in the S1914, the MFP cooperative server 120 associates the talk room of the post destination and the serial number of the MFP110 where the posting is possible with the chatbot of the chat service related to the application ID, and stores them as the connection information of the chatbot. At this time, a room ID and the like for uniquely identifying the talk room is stored in the talk room of the posting destination.

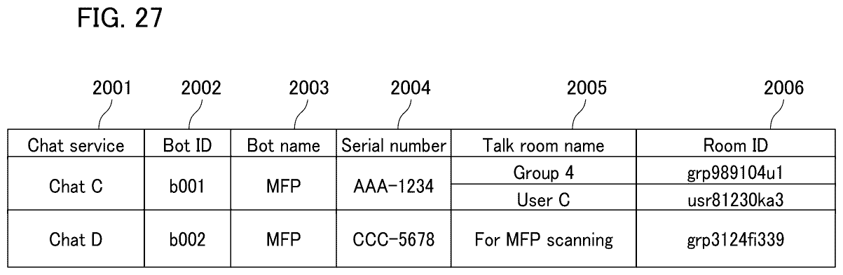

FIG. 27 is a diagram illustrating an example of chatbot connection information. The connection information of the chatbot is stored in the HDD 314 of the MFP cooperative server 120. The connection information of the chatbot includes, for example, a chat service name 2001, a bot ID 2002, a bot name 2003, a serial number 2004, a talk room name 2005, and a room ID 2006. The chat service name 2001 is the name of the chat service. The bot ID 2002 is an ID of chatbot uniquely indicating a bot added to the chat service indicated by the chat service name 2001. The bot name 2003 is the name of the chatbot at the time of posting to the chat server 130. The serial number 2004 is a serial number of the MFP 110 where a file and a message can be posted to the chat server by using the account of the chatbot. The talk room name 2005 is the name of a talk room in which the MFP 110 can post a file and a message using the account of the chatbot. The room ID 2006 is an ID uniquely identifying a talk room in which the MFP 110 can post a file and a message by using an account of the chatbot. That is, the room ID 2006 is an ID that corresponds to the talk room name 2005.

In S1915, the MFP cooperative server 120 transmits a message that the registration of the chatbot has been completed to the chat server 130. In S1916, the chat server displays a message that the registration of the chatbot has been completed in the talk room. A message 1110 as shown in FIG. 13 is a message indicating that the MFP has been registered as a chatbot in the talk room. Through the above-described chatbot registration processing, it is possible to transmit a file and a message from the MFP 110 to the chat server 130 and delete a posted file or message using the chatbot. A file posting 1111 as shown in FIG. 13 is an example of a case where a file of a scanned image and a message are posted from the MFP 110 to the chat server 130 with an account of the chatbot by the process as shown in FIG. 5. As shown in the file posting 1111, in a case where the file and message are posted by using the chatbot account, they are displayed as posted from the chatbot. The file and the message posted from the MFP 110 by the chatbot cannot be deleted even if the chat server 130 is accessed via the client PC 111 with the user account. Thus, in a case where a file and the like posted from the MFP 110 are deleted using a chatbot that is associated with the MFP 110, the deletion of posting from the MFP 110 described in the first embodiment is useful.

As described above, according to the present embodiment, it is possible to register a chatbot account associated with the MFP 110. For a post from the chatbot account associated with the MFP 110, it is possible to provide an instruction to delete the post by an operation from the MFP 110 by the processing as explained in the first embodiment.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-151689, filed Sep. 19, 2023, which is hereby incorporated by reference wherein in its entirety.

What is claimed is:

1. An image processing apparatus comprising:
at least one memory storing instructions; and
at least one processor executing the instructions causing the image processing apparatus to:
transmit image data obtained by scanning a document to an external server, wherein information corresponding to the image data transmitted to the external server is displayed on a display of a client terminal capable of communicating with the external server;
display a list in which logs of a plurality of jobs including a log of a job that transmits the image data to the external server are displayed;
receive selection of a log of a job that transmits the image data to the external server in the list; and
receive an instruction to delete information corresponding to the image data that has been transmitted to the external server in a job corresponding to the selected log, wherein information corresponding to the image data displayed on a display of the client terminal is deleted.

2. The image processing apparatus according to claim 1, wherein on a screen on which the list is displayed, in a case where the external server can delete information corresponding to the image data that has been transmitted to the external server in a job corresponding to the selected log, a button for receiving the deletion instruction is displayed in a selectable state.

3. The image processing apparatus according to claim 2, wherein a case where the information can be deleted by the external server is a case where the external server corresponds to a function of deleting display of a message transmitted to the external server.

4. The image processing apparatus according to claim 2, wherein in a case where a log that is not associated with a user who is logging in is selected on a screen on which the list is displayed, a button for receiving the deletion instruction is displayed in a non-selectable state or is not displayed.

5. The image processing apparatus according to claim 2, wherein in a case where a predetermined time has elapsed since the transmission of the image data corresponding to the selected log, a button for receiving the deletion instruction is displayed in a non-selectable state, or is not displayed.

6. The image processing apparatus according to claim 2,
wherein, in the list, as a log, at least one of a status of a job corresponding to the log, a file name of a file including image data transmitted in the job, a message transmitted together with the image data, a transmission destination to which the image data has been transmitted, and a user name of a user who has instructed transmission of the image data are displayed, and
wherein in a case where display of detailed information of a log selected in the list is instructed, a preview image of the transmitted image data is displayed.

7. The image processing apparatus according to claim 6, wherein in a case where the image processing apparatus receives information indicating that the information corresponding to the image data displayed on a display of the client terminal has been deleted by the external server, the status displayed as the log is updated from transmitted to deleted.

8. The image processing apparatus according to claim 1, wherein in a case where the information cannot be deleted by the external server, a message indicating that the information is erroneous is transmitted to the external server.

9. The image processing apparatus according to claim 1, wherein in a case where the information can be deleted by the external server and the image data has already been downloaded in the client terminal based on the information, a message indicating that the information is erroneous is transmitted to the external server.

10. The image processing apparatus according to claim 1, wherein the image data is transmitted to the external server via a cooperative server with which the image processing apparatus can communicate.

11. The image processing apparatus according to claim 1, wherein a log of a job in which the image data has been transmitted to the external server is managed by the external server in association with an identifier that identifies the information displayed on a display of the client terminal, and
wherein in a case where an instruction to delete the information is received, a request to delete the information is transmitted to the external server together with the identifier managed in association with the information.

12. The image processing apparatus according to claim 1, wherein the external server is a server that provides a chat service in which a message transmitted to the external server is displayed in a talk room displayed on a display of the client terminal.

13. A control method of an image processing apparatus, the method comprising:
transmitting image data obtained by scanning a document to an external server, wherein information corresponding to the image data transmitted to the external server is displayed on a display of a client terminal capable of communicating with the external server;
displaying a list in which logs of a plurality of jobs including a log of a job that transmits the image data to the external server are displayed;
receiving selection of a log of a job that transmits the image data to the external server in the list; and
receiving an instruction to delete information corresponding to the image data that has been transmitted to the external server in a job corresponding to the selected log, wherein information corresponding to the image data displayed on a display of the client terminal is deleted.

14. A non-transitory storage medium storing a control program of an image processing apparatus causing a computer to perform each step of a control method of the image processing apparatus, the method comprising:
transmitting image data obtained by scanning a document to an external server, wherein information corresponding to the image data transmitted to the external server is displayed on a display of a client terminal capable of communicating with the external server;
displaying a list in which logs of a plurality of jobs including a log of a job that transmits the image data to the external server are displayed;
receiving selection of a log of a job that transmits the image data to the external server in the list; and
receiving an instruction to delete information corresponding to the image data that has been transmitted to the external server in a job corresponding to the selected log, wherein information corresponding to the image data displayed on a display of the client terminal is deleted.
